(19) United States
(12) Patent Application Publication
(10) Pub. No.: US 2014/0308401 A1
(43) Pub. Date: Oct. 16, 2014

(54) Health Food Containing Rice and Flour and Manufacturing Method Thereof

(71) Applicant: Yat Hung TAM, New Territories (HK)

(72) Inventor: Yat Hung TAM, New Territories (HK)

(73) Assignee: WAN JIN SHAN LILMITED, New Territories (HK)

(21) Appl. No.: 13/864,211

(22) Filed: Apr. 16, 2013

(51) Int. Cl. A21D 13/00

(52) U.S. Cl. CPC A21D 13/0054
USPC 426/92; 426/558; 426/94; 426/283

(57) ABSTRACT

A health food made of grain and a manufacturing method thereof that keep its nutrition of the ingredients effectively, and take into account the health care effects at the same time. It contains the following ingredients: flour, egg yolk, butter, evaporated milk, yellow rice, tortoise powder, glabrous greenbrier rhizome powder, grass jelly powder, Ganoderma Lucidum powder. The rice and wheat flour of raw materials are processed into semi-finished products, and then fruits, vegetables, meats, eggs, seafood, and herbal medicines are added to make the foods containing rice and flour, which can effectively retain nutritional ingredients, not only to meet needs of carbohydrates, protein, fat, dietary fiber, minerals and vitamins of a human body, but also provide multiple health benefits, different flavors, being aesthetically appealing and taste good.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

1. Field of Invention

The present invention relates to a food and a manufacturing method thereof, and more particularly to a health food containing grains and a manufacturing method thereof.

2. Description of Related Arts

Food made of rice and wheat is enjoyed as staples by many people in many countries around the world. These foods are indispensible to many people around the world because they not only satisfy a person's hunger, but are good sources of protein, fats, vitamins and minerals which lend to better nutrition. Food made up of rice is able to provide a good source of energy, increase spleen health, comfort the stomach, and alleviate anxiety. Food made of up wheat is able to also increase spleen health, improve the kidneys, strengthen the heart, and calm nerves. Foods made from rice and wheat are able to be adapted to be made into many different flavored foods with various ingredients such as spices, vegetables, fruits, different types of meats, eggs, and fish. These types of foods are also advantageous in that they can be eaten hot or cold to provide an expanded versatility among the consumer.

Foods made and rice and wheat are also used for absorbing various types of liquid drinks such as milks, soy milks, and vegetable or fruit juices. For example, red juice, yellow juice, black juice, white juice, orange juice, green juice, and purple juice can be made into different colored rice and wheat foods. Rice and wheat foods can also be made into different colored flour foods such as sushi and rice balls with seafood and/or meats. Many people enjoy eating these different colored flour foods such as sushi and rice balls because they have special nutritional values and health protection functions. With all these roles adapted for rice and wheat foods, the manufacturing process for rice and wheat food cannot effectively maintain its original nutrition, maintain the of role of prominence in health care, and meet the demand for different tastes in food.

### SUMMARY OF THE PRESENT INVENTION

The present invention is advantageous in that it provides a health food comprising rice and flour ingredients and a manufacturing method thereof, wherein the technological problem of keeping the nutritional value and take into account the health care effects are solved.

The technological solution employed is as follows: a health food made of grain and manufacturing method thereof, wherein a unit of the health food contains at least 226. 795 grams of flour, 25 grams of egg yolk, 141.75 grams of butter, 28.35 grams of evaporated milk, 20 grams of white sugar, 1 grams of the yellow rice, 5 grams of tortoise shell powder, 5 grams of glabrous greenbrier rhizome, 5 grams of Chinese Mesona, 5 grams of Ganoderma lucidum powder, and 5 grams of honey water. The health food and be alternatively comprised of 200 grams of flour, 5 grams of milk, 50 grams of egg, 80 grams of margarine, 60 grams of lard oil, 20 grams of icing sugar, a little of salt, 150 grams of egg, 150 grams of milk, 50 grams of sugar, 135 grams of water, an amount of vanilla oil, 5 grams of black sesame powder, and 5 grams of tortoise jelly powder. An additional composition contains 60 grams of red rice, 60 grams of the yellow rice, 60 grams of black rice, 60 grams of white rice, 60 grams of orange rice, 60 grams of green rice, 60 grams of purple rice, and two pieces of layer which are preferably 1 mm thick, wherein the health food is layered in the following order from top to bottom: laver, red rice, yellow rice, black rice, white rice, orange rice, green rice, purple rice and laver, wherein each layer is 5-8 mm check and a unit of the health food weights 40 g, 50 g, 80 g, or 100 g.

The red rice of the present invention is comprised the following ingredients or a mass ratio thereof: 500 g of rice, 1520 g of water, 100 g of red bean, 20 g of red bean powder, 1 g of salt, and 1 g of sugar, wherein the manufacturing method for red rice comprises the steps of:

1. adding the red beans into 520 g of water in a container and cooking for 1 hour;

2. adding red bean powder, salt and sugar into the container, stirring to obtain red bean paste water;

3. adding rice and 1000 grams of water into a rice cooker and cooking to prepare cooked rice; and

4. mixing the red bean paste water and the rice and stirring until the red bean paste water is completely and evenly absorbed by the rice to prepare the red rice.

The yellow rice of the present invention comprises the following ingredients or a mass ratio thereof: 500 g of rice, 1050 g of water, 50 g of turmeric curry powder, 1 g of salt, and 1 g of sugar, wherein the manufacturing method for yellow rice comprises the steps of:

1. adding the turmeric curry powder, the salt, and the sugar into 50 g of water in a container;

2. stirring evenly to obtain a turmeric curry water;

3. adding the rice and 1000 g of water into a rice cooker and cooking rice; and

4. mixing the turmeric curry water and the rice until the turmeric curry water is completely and evenly absorbed by the rice to prepare the yellow rice.

The black rice of the present invention comprises the following ingredients or a mass ratio: 500 g of rice, 1120 g of water, 100 g of black sesame powder, 10 g of black sesame seeds, 10 g of tortoise shell powder, 10 g of glabrous greenbrier rhizome, 1 g of salt, and 1 grams of sugar, wherein the manufacturing method for black rice comprises the steps of:

1. adding the black sesame seed powder, the tortoise shell powder, the glabrous greenbrier rhizome, and 1120 g of water into a container and cook for 1 hour;

2. adding the salt and the sugar, and stirring evenly to obtain black sesame water;

3. adding rice and 1000 g of the black sesame water into a rice cooker and cooking rice; and

4. mixing the black sesame water and the rice until the black sesame water is completely and evenly absorbed by the rice to prepare the black rice.

The white rice of the present invention comprises the following ingredients or a mass ratio thereof: 500 g of rice, 1120 g of water, 100 g of copra, 20 g of coconut powder, 3 g of salt, and 3 g of sugar, wherein the manufacturing method for white rice comprises the steps of:

1. smashing the copra with 120 g of water and filtering to obtain coconut milk;

2. adding the coconut powder, the salt, and the sugar, and stirring evenly to obtain coconut water;

3. adding the rice and 1000 g of water into a rice cooker and cooking the rice; and

4. mixing the coconut water and the rice until the coconut water is completely and evenly absorbed by the rice to prepare the white rice.

The orange rice of the present invention comprises the following ingredients or a mass ratio thereof: 500 g of rice, 1120 g of water, 100 g of carrots, 20 g of carrots powder, 1 g of salt, and 1 g of sugar, wherein the manufacturing method for orange rice comprises the steps of:

1. smashing the carrot with 120 g of water. and filtering to obtain carrot juice;

2. adding the carrot powder, the salt, and the sugar, and stirring evenly to obtain carrot water;

3. adding rice and 1000 g of water into a rice cooker and cooking the rice; and

4. mixing the carrot water and the rice until the carrot water is completely and evenly absorbed by the rice to prepare the orange rice.

The green rice of the present invention comprises the following ingredients having a quality ratio: 500 g of rice, 1120 g of water, 100 g of spinach, 20 g of spinach powder, 1 g of salt, and 1 g of sugar, wherein the manufacturing method for green rice comprises the steps of:

1. cleaning the spinach and smashing it with 120 g of water and filtering to obtain spinach juice;

2. adding the spinach powder, the salt, and the sugar, and stirring evenly to obtain spinach water;

3. adding rice and 1000 g of water into a rice cooker and cooking the rice; and

4. mixing the spinach water and the rice until the spinach water is completely and evenly absorbed by the rice to prepare the green rice.

The purple rice of the present invention comprises the following ingredients or in a mass ratio there: 500 g of rice, 1120 g of water, 100 g of Colocasia Tonoimo, 20 g of Colocasia Tonoimo powder, 1 g of salt, and 1 g of sugar, wherein the manufacturing method for purple rice comprises the steps of:

1. peeling and cleaning the Colocasia Tonoimo, and then dicing and steaming the Colocasia Tonoimo in a food steamer;

2. smashing the steamed Colocasia Tonoimo and with 120 g of water to obtain a mixture of Colocasia Tonoimo paste and water;

3. adding the Colocasia Tonoimo powder, the salt, and the sugar, and stirring evenly to obtain Colocasia Tonoimo water;

4. adding rice and 1000 g of water into a rice cooker and cooking the rice; and

5. mixing the Colocasia Tonoimo water and the rice until the Colocasia Tonoimo water is completely and evenly absorbed by the rice to prepare the purple rice.

The red rice, the yellow rice, the black rice, the white rice, the orange rice, the green rice and/or the purple rice of the present invention can be provided in a rice bread, a fried tofu bubble, or a cylindrical pastry cup, wherein fruits, vegetables, meats, eggs and/or seafood are orderly placed on the rice. Alternatively, the fruits, vegetables, meats, eggs and/or seafood are orderly placed on the rice, and a plurality of layer sheets are respectively provided on the top and bottom side of the rice, wherein the meat is a cooked hot dog, the egg is fried on a single side or both sides, the seafood is a cooked meatball made of lobster or a piece of sliced salmon, the red vegetable is a piece of tomato and/or carrot, and the vegetable is a piece of lettuce.

The fried tofu bubble comprises the following ingredients or a mass ratio thereof: 25 g of rice and 3 g of cooking oil, which is made by the following manufacturing method comprising the steps of:

1. drying the tofu;

2. preparing the cooking oil in a container by heating to 60-70° C., and then adding the dried tofu into the container;

3. frying the dried tofu for 3 minutes, preferably using up the 3 g of edible oil; and

4. slicing an opening which has a depth of 0.5 mm in a each side of the fried tofu bubbles.

The rice bread of the present invention comprises the following ingredients or a mass ratio thereof: 415 g of high-gluten flour, 25 g of egg, 50 f of butter, 10 g of dried milk, 2 g of salt, 60 g of sugar, 15 g of baking powder, 225 g of warm water at 35°, 100 g of rice, 20 g of Colocasia Tonoimo powder, and 200 g of water, 20 g of Colocasia Tonoimo, which is made by the following manufacturing method comprising the steps of:

1. dicing the Colocasia Tonoimo, then adding the rice and cooking to obtain the cooked purple rice, and then evenly stirring;

2. preparing the beaten eggs;

3. adding the baking powder into the warm water, then adding the high-gluten flour, the beaten egg, the salt, and the sugar, and then stirring;

4. kneading the high-gluten flour mixture into a dough, then adding butter, and kneading evenly;

5. fermenting the kneaded dough for 1 hour;

6. dividing the fermented dough into 20 g of small dough, and then allowing them rest 10 minutes;

7. rolling the small dough with a rolling pin, then adding the purple rice, then evenly kneading, and then allowing to ferment for 30 minutes,

8. smearing the beaten eggs on surfaces of the fermented small dough;

9. baking them in an oven for 10 minutes at 20° C.; and

10. cutting each of the baked breads into two pieces.

The cooked meatball containing lobster of the present invention comprises the following ingredients or a mass ratio thereof: 200 g of lobster, 200 g of fish, 100 g of pork, 50 g of egg, 80 g of millet flour, 5 g of pepper powder, 500 g of water, 2 g of salt, and 2 g of sugar, which is made by the following manufacturing method comprising the steps of:

1. cutting up the fish;

2. shelling and cutting up the lobster;

3. cutting the pork;

4. mixing the cut fish, lobster meat, and pork, then adding the salt, sugar, and pepper powder, and then mixing beaten eggs into the meat mixture and stirring to obtain a meat paste;

5. adding the millet flour into the meat paste, and evenly stirring; and

6. squeezing the meat paste to obtain meatballs, wherein each of the meatballs has a 3 cm diameter, and then frying for 3 minutes at 60-70° C. in a frying-pan to obtain cooked meatballs made of lobster, fish, and pork meat.

The cylindrical crust cup of the present invention comprises the following ingredients or a mass ratio thereof: 200 g of flour, 60 g of egg, 50 g of butter, 20 g of evaporated milk, −1° C. ice water, 1 g of salt, and 1 g of sugar; which is made by the following manufacturing method comprising the steps of:

1. mixing the butter, the salt, and the sugar and stirring evenly;

2. adding the eggs and stirring evenly;

3. adding the flour, the evaporated milk, and the ice water, and kneading to obtain a dough;

4. rolling the dough to obtain a 1 mm thick flour wrapper, and dividing it into 20 g pieces of flour wrappers; and

5. rolling the pieces of flour wrapper by a crust tin to obtain crusts, and then baking them in an oven at 180° C. for 20 minutes to obtain cylindrical crust cups.

A method for manufacturing health food containing rice and wheat flour for egg tarts that comprises the following steps of:

1. according to a mass ratio, mixing 141.75 g of butter, 20 g of white sugar, 25 g of egg yolk and stirring evenly;

2. adding 226.795 g of flour, 1 g of the yellow rice, and 28.35 g of evaporated milk and kneading to obtain a dough;

3. molding the dough to obtain egg tarts;

4. transferring the egg tarts in the mold into an oven and baking at 180° C. for 20 minutes to obtain egg tarts, and preparing stuffing, wherein the stuffing comprises the steps of:

1. mixing 5 g of tortoise shell powder, 5 g of glabrous greenbrier rhizome, 5 g of Chinese Mesona, 5 g of Ganoderma Lucidum powder, and stirring evenly to obtain a tortoise jelly powder;

2. adding the tortoise jelly powder into a pot and adding 5 g of honey water and an amount of water then stirring to obtain a paste, and then adding boiling water and stirring for 15 minutes to obtain tortoise jelly paste, wherein the ratio of the tortoise jelly powder and the boiling water is 1:20; and

3. pouring the tortoise jelly paste into the baked egg tarts until the tortoise jelly paste fills 90% of the space of each of the baked egg tarts, and then allowing the tortoise jelly paste to naturally cool to room temperature to obtain tortoise jelly paste egg tarts.

A method for manufacturing health foods containing rice and flour ingredients for egg tarts comprises the following steps of:

1. adding 40° C. water to 20 g of icing sugar and mixing to obtain an amount of syrup;

2. adding a little salt, 60 g of melted lard, 80 g of margarine, and 5 g of milk, and stirring to obtain a thin paste;

3. adding 50 g of eggs and stirring evenly;

4. adding 200 g of flour and kneading to obtain a dough; and

5. adding the dough into a mold and pressing to obtain egg tarts, and then preparing the stuffing, wherein the stuffing comprises the steps of:

1. dissolving 50 g of white sugar in 135 g of water to obtain an amount of syrup, then stirring 150 g of egg to obtain an egg liquid, then adding 150 g of the milk, the syrup, 5 g of black sesame powder, 5 g of tortoise jelly powder, and a little vanilla oil, and then stirring evenly to obtain a black juice; and

2. pouring the black juice into the baked egg tarts until the black juice fills 90% of the space in each of the baked egg tarts, then transferring the egg tarts into an oven and baking at 180° C. for 20 minutes, and then allowing the tortoise jelly paste egg starts to naturally cool to room temperature to obtain a tortoise jelly paste egg tart.

A method for manufacturing health foods comprised of rice and flour ingredients comprises the following steps of:

1. adding a piece of 1 mm layer sheet on the bottom of a mold;

2. covering evenly with 60 g of the red rice, 60 g of the yellow rice, 60 g of the black rice, 60 g of the white rice, 60 g of an orange rice, 60 g of green rice, and 60 grams of purple rice;

3. covering with a piece of 1 mm layer sheet on the purple rice layer by pressing a mold on the seaweed layer sheet to obtain rice food having a cross section with seven colors;

4. dividing the seven color rice into blocks perpendicular to the layer sheets, wherein the blocks can have a block size of 40 g, 50 g, 80 g or 100 g and each of rice layers has a thickness of 5-8 mm.

Compared with the prior art, the present invention processes the raw materials of colored vegetables, milk and bean juices, and rice and wheat flour into semi-finished products. Fruits, vegetables, meats, eggs, seafood, or herbal medicines are then added to make the foods containing the rice and flour to meet the nutritional requirements of the human body. This is advantageous because rice and flour are able to effectively retain the nutritional ingredients from grains, fruits, vegetables, milk, beans, meats, eggs, and seafood. In addition to meeting the body's requirements for carbohydrates, protein, fat, dietary fiber, minerals, and vitamins, the present invention provides multiple health benefits, has different flavors, looks and tastes good, and which is suitable for all kinds of people

Still further objects and advantages will become apparent from a consideration of the ensuing description and drawings.

These and other objectives, features, and advantages of the present invention will become apparent from the following detailed description, the accompanying drawings, and the appended claims.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

Referring to the drawings and the embodiments, the present invention is further described in detail as follows. The health food containing rice and flour ingredients of the present invention contains a rice food, a flour food, and/or combination thereof.

The rice food comprises 60 grams of the red rice, 60 grams of the yellow rice, 60 grams of the black rice, 60 grams of the white rice, 60 grams of orange rice, 60 grams of green rice, and 60 grams of the purple rice. The flour food is an egg tart or crust made of flour. The combination containing rice and flour are egg tarts, cakes, or sushi containing rice and flour.

A first method for making health foods containing rice and flour ingredients of the present invention comprises the following steps for preparing egg tarts:

1. according to a mass ratio, mixing 141.75 grams of butter, 20 grams of white sugar, and 25 grams of egg yolk and then stirring evenly;

2. adding 226.795 grams of flour, 1 gram of the yellow rice, and 28.35 grams of evaporated milk, and then kneading to obtain a dough;

3. molding the dough to obtain egg tarts;

4. transferring the egg tart sheets in the mold (tart mold) into an oven and then baking at 180° C. for 20 minutes to obtain egg tarts.

This first method for making health foods containing rice and flour ingredients further comprises preparing stuffing which comprises the following steps:

1. mixing 5 grams of tortoise shell powder, 5 grams of glabrous greenbrier rhizome, 5 grams of Chinese Mesona, and 5 grams of Ganoderma Lucidum powder and then stirring evenly to obtain a tortoise jelly powder;

2. adding the tortoise jelly powder into a pot and adding 5 grams of honey water and an amount of water, then stirring to obtain a paste, then adding boiling water and stirring, wherein the ratio of the tortoise jelly powder and the boiling water is 1:20, and then boiling the mixture on the stove for 15 minutes to obtain a tortoise jelly paste;

3. pouring the tortoise jelly paste into the baked egg tarts until the tortoise jelly paste fills 90% of the space in each of the baked egg tarts, and then allowing the baked egg starts to naturally cool to room temperature to obtain tortoise jelly paste egg tarts.

A second method for manufacturing health foods containing rice and flour ingredients for egg tarts comprises the following steps of:

1. adding 40° C. water to 20 grams of icing sugar and mixing to obtain an amount of syrup;

2. adding a little salt, 60 grams of melted lard, 80 grams of margarine, and 5 grams of milk and then stirring to obtain a thin paste;

3. adding 50 grams of eggs and stirring evenly;

4. adding 200 grams of flour and kneading to obtain a dough; and

5. adding the dough into a mold and pressing to obtain egg tarts.

This second method for manufacturing health foods containing rice and flour ingredients for egg tarts also further comprises preparing stuffing which comprises the following steps of:

1. dissolving 50 grams of white sugar in 135 grams of water to obtain an amount of syrup, then stirring 150 grams of egg to obtain an egg liquid, then adding 150 grams of milk, the amount of syrup, 5 grams of black sesame powder, 5 grams of tortoise jelly powder, and little vanilla oil, and them stirring evenly to obtain a black juice;

2. pouring the black juice into the baked egg tarts until the black juice fills 90% of the space in each of the baked egg tarts.

This second method for manufacturing health foods containing rice and flour ingredients for egg tarts also further comprises preparing pastry tortoise jelly paste egg tarts:

1. transferring the egg tarts in the mold and the black juice in the egg tarts into an oven and baking at 180° C. for 20 minutes, and then taking them out of the oven and allowing them to naturally cool to room temperature to obtain the pastry tortoise jelly paste egg tarts.

A third method for manufacturing health foods containing rice and flour ingredients comprises the following steps of:

1. adding one piece of 1 mm layer sheet on the bottom of a rectangle mold, for example a lunch-box, wherein the layer sheet is cooked and dried;

2. covering 60 grams of the red rice on the layer sheet evenly;

3. covering 60 grams of the yellow rice on the red rice evenly;

4. covering 60 grams of the black rice on the yellow rice evenly;

5. covering 60 grams of the white rice on the black rice evenly;

6. covering 60 grams of an orange rice on the white rice evenly;

7. covering 60 grams of green rice on the orange rice evenly;

8. covering 60 grams of purple rice on the green rice evenly;

9. covering a piece of 1 mm layer sheet on the purple rice evenly, and then pressing a mold on the layer sheet to obtain rice food having seven-color cross-section, wherein the layer sheet is cooked and dried;

10. dividing the seven-color rice into blocks perpendicular to the layer sheets, wherein the blocks can have a block size of 40 g, 50 g, 80 g, or 100 g, and each of rice layers has a thickness of 5-8 mm.

The red rice comprises the following ingredients or having a mass ratio thereof: 500 grams of rice, 1520 grams of water, 10 grams of red bean, 20 grams of red bean powder, 1 gram of salt, and 1 gram of sugar. The red rice is made by the following method, which comprising the steps of:

1. adding the red bean into 520 grams of water and boiling in a pot for 1 hour;

2. adding the boiled red bean and the remaining water into a container, and adding the red bean powder, the salt, and the sugar, and then stirring evenly to obtain a red bean paste;

3. adding the rice and 1000 grams of water in a rice cooker and cooking, and then pouring the cooked rice into another container;

4. pouring the red bean paste into the another container, and mixing and stirring repeatedly until the red bean paste is evenly and completely absorbed;

5. coating a piece of wet cloth on the stirred rice for 1 hour to obtain a red rice.

It is worth mentioning that the rice cooker is a common rice cooker, and the red bean powder is the kind of powder from grinded red beans.

The yellow rice comprises the following ingredients having or a having a mass ratio thereof: 500 grams of rice, 1050 grams of water, 50 grams of turmeric curry powder, 1 gram of salt, and 1 gram of sugar. The yellow rice is made by the following method, which comprising the steps of:

1. adding the turmeric curry powder into 52 grams of water, salt, and sugar;

2. stirring to obtain an amount of yellow curry water;

3. adding the rice and 1000 grams of water in a rice cooker and cooking;

4. mixing the yellow curry water and the cooked rice, and then stirring until the yellow curry water is evenly and completely absorbed;

5. coating a piece of wet cloth on the stirred rice for 1 hour to obtain the yellow rice.

The black rice contains the following ingredients or having a mass ratio thereof: 500 grams of rice, 1120 grams of water, 100 grams of black sesame powder, 10 grams of black sesame, 10 grams of tortoise shell powder, 10 grams of glabrous greenbrier rhizome, 1 gram of salt, and 1 gram of sugar. The black rice is made by the following method, which comprising the steps of:

1. adding the black sesame powder, the black sesame, the tortoise shell powder, the glabrous greenbrier rhizome powder, and 120 grams of water into a pot and boiling for 1 hour;

2. adding the salt and the sugar, and then stirring evenly to obtain the black sesame water;

3. adding the rice and 1000 grams of water into a pot and cooking;

4. mixing the black sesame water and the cooked rice, and then stirring until the black sesame water is completely and evenly absorbed;

5. coating a piece of wet cloth on the stirred rice for 1 hour to obtain the black rice.

The white rice contains the following ingredients or having a mass ratio thereof: 500 grams of rice, 1120 grams of water, 100 grams of copra, 20 grams of coconut powder, 3 gram of salt, and 3 gram of sugar. The white rice is made by the following method, which comprising the steps of:

1. adding the copra into 120 grams of water, and then pulping and filtering to obtain coconut juice;

2. adding the coconut powder, the salt, and the sugar, and then stirring evenly to obtain the coconut water;

3. adding the rice and 1000 grams of water into a pot and cooking;

4. mixing the coconut water and the cooked rice, then and stirring until the coconut water is completely and evenly absorbed;

5. coating a piece of wet cloth on the stirred rice for 1 hour to obtain the white rice.

The orange rice contains the following ingredients or having a mass ratio thereof: 500 grams of rice, 1120 grams of water, 100 grams of carrots, 20 grams of carrots powder, 1 gram of salt, and 1 gram of sugar. The orange rice is made by the following method, which comprising the steps of:

1. adding the carrot into 120 grams of water, and then pulping and filtering to obtain the carrot juice;

2. adding the carrot powder, the salt, and the sugar, and then stirring evenly to obtain the carrot water;

3. adding the rice and 1000 grams of water into a pot and cooking;

4. mixing the carrot water and the cooked rice, and then stirring until the carrot water is completely and evenly absorbed;

5. coating a piece of wet cloth on the stirred rice for 1 hour to obtain the orange rice.

The green rice contains the following ingredients or having a mass ratio thereof: 500 grams of rice, 1120 grams of water, 100 grams of spinach, 20 grams of spinach powder, 1 gram of salt, and 1 gram of sugar. The green rice is made by the following method, which comprising the steps of:

1. adding the spinach into 120 grams of water, and then pulping and filtering to obtain the spinach juice;

2. adding the spinach powder, the salt, and the sugar, and then stirring evenly to obtain the spinach water;

3. adding the rice and 1000 grams of water into a pot and cooking;

4. mixing the spinach water and the cooked rice, and then stirring until the spinach water is completely and evenly absorbed;

5. coating a piece of wet cloth on the stirred rice for 1 hour to obtain the green rice.

The purple rice contains the following ingredients or having a mass ratio thereof: 500 grams of rice, 1120 grams of water, 100 grams of Colocasia Tonoimo, 20 grams of Colocasia Tonoimo powder, 1 gram of salt, and 1 gram of sugar. The purple rice is made by the following method, which comprising the steps of:

1. peeling and cleaning the Colocasia Tonoimo, and then dicing and steaming for 1 hour in a food steamer,

2. smashing the steamed Colocasia Tonoimo with 120 grams of water to obtain a mixture of Colocasia Tonoimo paste and water;

3. adding the Colocasia Yonoimo powder, the salt, and the sugar, and then stirring evenly to obtain Colocasia Tonoimo water;

3. adding rice and 1000 grams of water into a rice cooker and cooking the rice; \

4. mixing the Colocasia Tonoimo water and the rice and stirring until the Colocasia Tonoimo water is completely and evenly absorbed by the rice to prepare the purple rice.

The red rice, the yellow rice, the black rice, the white rice, the orange rice, the green rice and/or the purple rice can be provided in a rice bread, a fried tofu bubble, or a cylindrical pastry cup, wherein fruits, vegetables, meats, eggs, and/or seafood are orderly placed on the rice. Alternatively, fruits, vegetables, meats, eggs, and/or seafood may be provided orderly on the rice, wherein a plurality of the layer sheets are respectively provided on the top and bottom side of the rice. The meat is a cooked hot dog, the egg is an egg fried on a single side or both sides, the seafood is a cooked meatball made of lobster or a piece of sliced salmon, the red vegetable is a piece of tomato and/or carrot, and the vegetable is a piece of lettuce.

The fried tofu bubble comprises the following ingredients or a mass ratio thereof: 25 g of rice and 3 g of cooking oil. The fried tofu bubble is made by the following manufacturing method comprising the steps of:

1. drying the tofu;

2. adding 250 gram of cooking oil into a pot and heating it to 60-70° C., and then adding the dried tofu into the pot;

3. frying the dried tofu for 3 minutes, preferably using up 3 grams of cooking oil, and then removing the dried tofu from the pot and placing it on an oil rack to drain excess oil; and

4. slicing an opening in each of the sides of the of fried tofu bubbles having a depth of 0.5 mm.

The bread containing rice and flour comprises the following ingredients or a mass ratio thereof: 415 grams of high-gluten flour, 25 grams of egg, 50 grams of butter, 10 grams of dried milk, 2 grams of salt, 60 grams of sugar, 15 grams of baking powder, 225 grams of 35° C. warm water, 100 g of rice, 20 grams of Colocasia Tonoimo powder, 200 grams of water, and 20 grams of Colocasia Tonoimo. The bread containing rice and flour is made by the following manufacturing method comprising the steps of:

1. dicing a Colocasia Tonoimo, then adding the rice and cooking to obtain the cooked purple rice, and then stirring evenly;

2. preparing the beaten eggs;

3. adding the baking powder into the warm water, then adding the high-gluten flour, then adding the beaten egg, the salt, and the sugar, and then stirring evenly;

4. kneading the high-gluten flour mixture into a dough, then adding butter, and kneading evenly;

5. fermenting the kneaded dough for 1 hour;

6. dividing the fermented dough into 20 grams of small dough, and then leaving them to rest for 10 minutes;

7. rolling the small dough with a rolling pin, then adding the purple rice, then kneading evenly, and then allow the combination to ferment for 30 minutes,

8. smearing the beaten eggs on surfaces of the small fermented dough;

9. baking them in an oven for 10 minutes at 200° C.;

10. cutting each of the baked breads into two pieces to finish the manufacturing method for the bread containing rice and flour.

The cooked hot dog comprises the following ingredients or a mass ratio thereof: 50 grams of casing, 100 grams of chicken, 100 grams of pork, 100 grams of beef, 100 grams of corn kernels, 300 grams of water, 2 grams of salt, and 2 grams of sugar. A method for manufacturing cooked hot dogs comprises the following steps of:

1. chopping the chicken, the pork and the beef;

2. adding the corn kernels, the salt, and the sugar into the chopped chicken, pork, and beef mixture and stirring to obtain a meat stuffing;

3. cleaning the casings and adding the meat stuffing into the casings, and sealing the casings to form the hot dogs; and

4. adding the hot dogs into a steamer to steam at 100° C. for 30 minutes to obtain cooked hot dogs.

The cooked lobster meatball comprises the following ingredients or having a mass ratio thereof: 200 grams of lobster, 200 grams of fish, 100 grams of pork, 50 grams of egg, 80 grams of millet flour, 5 grams of pepper powder, 500 grams of water, 2 grams of salt, and 2 grams of sugar. A method for manufacturing cooked lobster meatball comprises the following steps of:

1. cutting up the fish;

2. shelling and cutting up the lobsters;

3. cutting up the pork;

4. mixing the cut fish, lobster meat, and pork, then adding the salt, the sugar and the pepper powder, then mixing beaten eggs into the meat mixture, and then stirring to obtain a meat paste;

5. adding the millet flour into the meat paste and stirring evenly; and

6. squeezing the meat paste to obtain meatballs comprised of lobster, wherein each of the meatballs has a 3 cm diameter, and then frying for 3 minutes at 60-70° C. in a frying-pan to obtain cooked meatballs comprised of lobster.

The cylindrical pastry cup comprises the following ingredients or having a mass ratio thereof: 200 grams of flour, 50 grams of egg (one egg), 50 grams of butter, 20 grams of evaporated milk, −1° C. of ice water, 1 gram of salt, and 1 gram of sugar. The cylindrical pastry cup is made by the following manufacturing method comprising the steps of:

1. mixing the butter, the salt, and the sugar, and stirring evenly;

2. adding the eggs, and stirring evenly;

3. adding the flour, the evaporated milk, and the ice water, and kneading to obtain a dough (the amount of ice water is adapted from the requirement to knead the dough);

4. rolling the dough to obtain a 1 mm flour wrapper and dividing it into 20 grams of pieces of flour wrapper; and

5. rolling the pieces of flour wrapper by a crust tin to obtain crusts, and then baking the crusts in an oven at 180° C. for 20 minutes to obtain cylindrical crust cups.

The sliced cooked salmon is made by the following method comprising the steps of:

1. cutting the head off the salmon, and cutting open the salmon from the back to the maw thereof;

2. removing the bones from the salmon with bone forceps; and

3. slicing the salmon into pieces at the direction vertical to fishlines of the salmon, wherein each piece of salmon is 20 grams, and baking the pieces of salmon to obtain sliced cooked salmon.

Example 1: the tortoise jelly paste egg tart further comprises an egg tart further comprising the following ingredients or having a mass ratio thereof: 226.795 grams of flour, 25 grams of egg yolk (one yolk), 141.75 grams of butter, 28.35 grams of evaporated milk, 20 grams of white sugar, 1 gram of the yellow rice, and ice water.

The tortoise jelly paste egg tart further comprises tortoise jelly paste further comprising the following ingredients or having a mass ratio thereof: 5 grams of tortoise shell powder, 5 grams of glabrous greenbrier rhizome, 5 grams of Chinese Mesona, 5 grams of Ganoderma Lucidum powder, and 5 grams of honey water.

A manufacturing method for preparing the egg tart casing comprises the following steps of:

1. mixing the butter and the sugar and stirring evenly;

2. adding the egg yolk, and then stirring;

3. adding the flour, the yellow rice, the evaporated milk, and the ice water, and then kneading to obtain a dough;

4. rolling the dough into a sheet and cutting it into egg tart blanks, and then putting the egg tart blanks into a mold and squeezing to obtain the egg tart casings; and

5. putting the egg tart casings into an oven and baking at 180° C. for 20 minutes to obtain the egg tart casings.

The tortoise jelly paste egg tart further comprises preparing stuffing further comprising the following steps:

1. mixing the tortoise shell powder, the glabrous greenbrier rhizome, the Chinese Mesona, the Ganoderma Lucidum powder, and then stirring evenly to obtain the tortoise jelly powder;

2. adding the tortoise jelly powder to a pot, then adding the honey water and an amount of water, then stirring to obtain a paste, then adding boiling water and stirring, wherein the ratio of the tortoise jelly powder and the boiling water is 1:20, and then boiling on the stove for 15 minutes to obtain the tortoise jelly paste; and

3. pouring the tortoise jelly paste into the baked egg tarts until the tortoise jelly paste fills 90% of the space in each of the baked egg tarts, and then allowing the baked egg tarts to naturally cool to room temperature to obtain the tortoise jelly paste egg tarts.

The tortoise jelly paste egg tart has a golden casing, which tastes crunchy and has a crisp golden appearance, and the black tortoise jelly paste is delicious, slippery, and sweet.

### Example 2

The tortoise jelly paste egg tart comprises an egg tart further comprised of following raw ingredients or having a mass ratio: 226.795 grams of flour, 25 grams of egg yolk (one yolk), 60 grams of butter, 28. 35 grams of evaporated milk, 20 grams of white sugar, 1 gram of the yellow rice, and ice water.

The tortoise jelly paste egg tart further comprises a tart stuffing further comprised of the following ingredients: 150 grams of egg (3 eggs), 150 grams of milk, 50 grams of white sugar, 135 grams of water, a little vanilla oil, 5 grams of black sesame powder, and 5 grams of tortoise jelly paste powder. The manufacturing method for preparing the egg tart casings comprises the following steps of:

1. adding 40° C. water to the icing sugar and mixing to obtain an amount of syrup;

2. adding a little salt, the melted lard, the margarine, and the milk, and then stirring to obtain a thin paste;

3. adding the eggs slowly and stirring evenly;

4. adding the flour and kneading to obtain a dough; and

5. adding the dough into a mold and pressing to obtain egg tart casings.

The tortoise jelly paste egg tart further comprises preparing a stuffing comprising the following steps:

1. dissolving the white sugar in the water to obtain an amount of syrup, then stirring the eggs to obtain an egg liquid, then adding the milk, the syrup, the black sesame powder, the tortoise jelly powder, and a little vanilla oil, and then stirring evenly to obtain the black juice; and

2. pouring the tortoise jelly paste into the baked egg tarts until the tortoise jelly paste fills 90% of the space in each of the baked egg tarts, then baking in the oven at 180° C. for 20 minutes, and then allowing the baked egg tarts to naturally cool to room temperature to obtain the tortoise jelly paste egg tarts.

The tortoise jelly paste egg tart has a golden casing, which tastes crunchy and has a crisp golden appearance, and the black tortoise jelly paste is delicious, slippery, and sweet.

### Example 3

The red rice comprises the following ingredients or having a mass ratio thereof: 15 grams of red rice, 20 grams of sliced cooked salmon, 10 grams of tomato, 10 grams of lettuce, 10 grams of sliced carrots, and two pieces of purple laver. The manufacturing method comprises the following steps of:

1. pressing the red rice into a flat oval shape; and

2. placing the sliced cooked salmon, sliced tomato, sliced lettuce, and sliced carrot, then wrapping tightly, and then packaging.

### Example 4

The red rice comprises the following ingredients or having a mass ratio thereof: 15 grams of red rice, 20 grams of sliced cooked hot dog, 10 grams of sliced tomato, 10 grams of lettuce, 10 grams of sliced carrots, and two pieces of purple laver. The manufacturing method comprises the following steps of:

1. pressing the red rice into a flat oval shape; and

2. placing the sliced cooked hot dog, sliced tomato, sliced lettuce, and sliced carrot, then wrapping tightly, and then packaging.

### Example 5

The red rice purple roll comprises the following ingredients or having a similar ratio thereof: 80 grams of red rice, 40 grams of sliced cooked salmon, 10 grams of tomato, 1 grams of lettuce, 10 grams of sliced carrots, a piece of purple laver, and two cooked hot dogs, wherein the two hot dogs have an approximate weight of 40 g. The manufacturing method comprises the following steps of:

1. slicing the cooked salmon into strips, wherein each of strips is approximately 20 g;

2. placing a piece of layer on a bamboo mat, then placing the red rice on the piece of laver, then placing two pieces of sliced cooked salmon, two cooked hot dogs, the sliced tomato, the sliced carrots and lettuce on the red rice and rolling to obtain an elongated strip, and then pressing the contents; and

3. cutting the rolled red rice purple roll into six blocks, and packaging.

### Example 6

The red rice contains comprises the following ingredients or having a mass ratio thereof: 20 grams of fried tofu bubble, 15 grams of red rice, 20 grams of sliced meatball containing lobster, 10 grams of sliced tomato, and 10 grams of sliced carrot. The manufacturing method comprises the following steps of:

1. smashing the inner of the fried tofu bubble;

2. putting the sliced meatball containing lobster, sliced tomato, and sliced carrots on the red rice, and then packaging.

### Example 7

The red rice sausage contains the following ingredients or having a mass ratio thereof: 100 mm casing for sausage, 500 grams of rice, 100 grams of red bean, 20 grams of red bean powder, 1500 grams of water, 100 grams of peanut, 20 grams of small shrimp, 10 grams of vegetable oil, 2 grams of salt, and 2 grams of sugar. The manufacturing method comprises the following steps of:

1. cleaning the red beans, and putting them into 520 grams of water in a pot, then boiling for 1 hour, then taking the red beans out of the boiled bean water;

2. cleaning the rice, then adding the red beans and the boiled bean water, and then soaking for 6 hours;

3. cleaning the peanuts, and then soaking in water for 6 hours;

4. adding the small shrimp, then soaking in water for 10 minutes, and then chopping;

5. cleaning the casings, and then adding water to soak for 2 hours;

6. adding the chopped small shrimp into a pot to fry for a few minutes per the consumers preference, then adding the red bean powder, the salt, the sugar, and the soaked rice, and then stirring to obtain the red rice stuffing;

7. pouring the vegetable oil into the casings for sausage, and then filling the red rice stuffing in the casings;

8. putting the red rice sausage in the steamer, and steaming for 30 minutes; and

9. cutting the red rice sausage into red rice sausage pieces, wherein each of the pieces of the red rice sausage is approximately 20 g, and then packaging.

### Example 8

The red rice bread roll comprises the following ingredients or having a mass ratio thereof: 100 grams of red rice, 2 pieces of rice bread, 20 grams of sliced cooked hot dog, 10 grams of sliced tomato, 10 grams of lettuce, and 10 grams of sliced carrot. The manufacturing method comprises the following steps of:

1. flattening 50 grams of the red rice;

2. putting the cooked hot dogs in the middle of the flattened red rice, and then flattening another 50 grams of the red rice on the flattened red rice;

3. pressing by a mold to obtain a roll;

4. placing respectively the sliced tomato, lettuce, and sliced carrots on the two rice breads;

5. placing the roll on one of the two rice breads; and

6. placing another rice bread on the roll, then clamping, and then packaging.

### Example 9

The red rice egg casing sushi comprised of the following ingredients or having a mass ratio thereof: 20 grams of red rice, 15 grams of sausage, 2 grams of sesame seeds, and 2 grams of crab roe. The mold for egg casings is made of polyethylene (PE) or polypropylene (PP). The manufacturing method comprises the following steps of:

1. cutting the sausage into pieces;

2. adding the red rice into the mold for egg casings, then molding, and then removing the red rice; and

3. spreading the pieces of sausage, the sesame seeds, and the crab roes on the red rice, and then packaging.

### Example 10

The red rice cylindrical pastry cup sushi comprises a cylindrical pastry cup comprised the following ingredients or having a mass ratio thereof: 30 grams of red rice, 20 grams of sausage, 2 grams of sesame seeds, and 2 grams of crab roe. The manufacturing method comprises the following steps of:

1. cutting the sausage;

2. adding the red rice into the cylindrical pastry cup; and

3. spreading the cut sausage, the sesame seeds, and the crab roes on the red rice, and then packaging.

### Example 11

The red rice icing moon cake comprises the following ingredients or having a mass ratio thereof: 50 grams of cooked low-gluten flour, 50 grams of cooked glutinous rice flour, 10 grams of the red bean water, 40 grams of sugar, 180 grams of milk, 50 grams of condensed milk, 50 grams, and 1400 grams of the red rice. The manufacturing method comprises the following steps of:

1. adding the cooked low-gluten flour, the cooked glutinous rice flour, the red bean water, the sugar, the milk, and the condensed milk into a container, then stirring to a paste, and then steaming for 30 minutes to obtain a rice dough;

2. removing the rice dough, then cooling to room temperature, and then placing in a 4° C. ice chamber for 2 hours;

3. kneading the dough evenly, then wrapping in plastic wrap, and then stewing for 15 minutes;

4. dividing the dough into blocks, wherein each of blocks is approximately 50 grams, then pressing and rolling into a circular casing, and then packaging 70 grams of the red rice in the circular casing; and

5. molding the dough wrapping with the red rice in a cake tin to obtain a red rice icing moon cake, and then packaging.

### Example 12

The red rice egg yolk moon cake comprises the following ingredients or having a mass ratio thereof: 140 grams of cooked low-gluten flour, 40 grams of cream, 53 grams of sugar, 13 grams of milk powder, 20 grams of maltose, 50 grams of egg, 2 grams of salt, 600 grams of red rice, and 20 salted egg yolks which are 200 g in total. The manufacturing method comprises the following steps of:

1. adding the cream and the sugar into a container, then stirring evenly, then adding the milk powder and the maltose, and then stirring evenly;

2. adding the egg yolk two at a time, then stirring evenly, then adding the salt, and then stirring evenly to obtain an egg paste;

3. sieving the low-gluten flour and adding the egg paste, and then kneading into a dough;

4. wrapping the dough in plastic wrap and resting the dough for 30 minutes;

5. cooking the salted egg yolks;

6. flattening the dough, then packaging 30 grams of the red rice on the flattened dough, and then adding a cooked egg yolk on the flattened dough to obtain the moon cake;

7. sprinkling water on the moon cake and transferring it into an oven;

8. First, baking for 10 minutes at 250° C., then baking at 200° C. for 10 minutes; all the while painting egg whites on the moon cake at a predetermined interval between the two baking times; and

9. baking at 250° C. for 5 minutes, then baking at 200° C. for 20 minutes, then removing from the oven and allowing to naturally cool, and then packaging.

### Example 13

The red rice dumpling comprises the following ingredients or having a mass ratio thereof: 300 grams of glutinous rice, 300 grams of pearl rice, 600 grams of streaky pork, 100 grams of red bean, 200 grams of water, 100 grams of beef, 100 g of tomato, 10 salted egg yolk (100 g), 20 dumpling leaves, 1 gram of salt, 1 gram of sugar, and 2 grams of soy sauce. The manufacturing method comprises the following steps of:

1. cleaning the red beans and adding them into a pot, and then boiling for 40 minutes;

2. cleaning the glutinous rice and the pearl rice, then adding both into the red bean water, and then soaking them in the water with red beans for 2 hours;

3. removing the contents and allowing them to drain;

4. cleaning the pork and the beef, then cutting them into strips, then adding the salt, the sugar, and the soy sauce, and then salting for 2 hours;

5. slicing the tomato;

6. adding the dumpling leaves in boiling water to cook for 1 minute at 100° C.;

7. taking two dumpling leaves and folding them into a funnel shape, then adding 60 grams of soaked glutinous rice and pearl rice, 60 grams of streaky pork, 10 grams of tomato, 10 grams of beef, and 1 egg yolk, then forming to obtain a rice dumpling, and then fastening tightly; and

8. boiling for 4 hours, then allowing the rice dumplings to naturally cool, and then packaging.

### Example 14

The red rice tortoise jelly paste tart comprises the following ingredients or having a mass ratio thereof: 200 grams of flour, 200 grams of eggs (4 eggs, 170 grams of milk, 80 grams of vegetable oil, 70 grams of sugar, 1 gram of salt, 150 grams of water, 1 gram of vanilla oil, 1 gram of black sesame powder, 1 gram of tortoise shell powder, 1 gram of glabrous greenbrier rhizome, 1 gram of grass jelly, and 1 gram of red rice. The manufacturing method comprises the following steps of:

1. adding 25 grams of the water into 20 grams of sugar to obtain an amount of syrup;

2. adding the salt, the vegetable oil, and 20 grams of milk, and then stirring evenly;

3. adding 2 eggs and stirring to obtain the corresponding egg liquid;

4. adding the flour and kneading to obtain a dough;

5. flattening the dough into a round tart casing, and then adding into a tart mold and compacting;

6. stirring in the 2 eggs to obtain the egg liquid, then mixing with 150 grams of milk, then pouring in 50 grams of sugar, 125 grams of water, 1 gram of the black sesame powder, 1 gram of the tortoise shell powder, 1 gram of the glabrous greenbrier rhizome powder, 1 gram the grass jelly powder, 1 gram the red rice, 1 gram and the vanilla oil, and then stirring to obtain the black egg juice;

7. pouring the black egg juice into the tart mold having an egg tart casing until 90% of the space of the tart mold is filled; and

8. placing in an oven and baking for 20 minutes at 180° C., then removing from the oven and allowing the black egg juice tart to naturally cool.

### Example 15

The red rice fried hot dog roll comprises the following ingredients or having a mass ratio thereof: 30 grams of the red rice, 15 grams of cooked hot dog, 10 grams of flour, 50 grams of egg (a single egg), and 20 grams of flour. The manufacturing method comprises the following steps of:

1. spreading the red rice;

2. placing the hot dogs among the red rice;

3. kneading the hot dogs and red rice into a round roll;

4. coating the round roll with flour;

5. coating evenly with egg liquid;

6. coating evenly with flour; and

7. frying the round roll coated with flour and egg liquid at 180° C. in a pot of oil until the surface of the round roll is golden brown, then removing it from the pot and allowing the round roll to drain excess oil, and then packaging.

### Example 16

The yellow rice comprises the following ingredients or having a mass ratio thereof: 15 grams of the yellow rice, 20 grams of sliced cooked salmon, 20 grams of sliced hot dog, 10 grams of tomato, 10 grams of lettuce, 10 grams of sliced carrots, and 2 grams of purple layer (2 pieces). The manufacturing method comprises the following steps of:

1. pressing the yellow rice into a flat oval shape; and

2. placing sliced cooked salmon, sliced tomato, sliced lettuce, and sliced carrots on the yellow rice, then wrapping tightly, and then packaging.

### Example 17

The yellow rice is comprised the following ingredients or having a mass ratio thereof: 15 grams of the yellow rice, 20 grams of sliced cooked hot dog, 10 grams of sliced tomato, 10 grams of lettuce, 10 grams of sliced carrots, and 2 grams of purple laver. The manufacturing method comprises the following steps of:

1. pressing the yellow rice to into a flat oval shape;

2. placing the sliced cooked hot dog, sliced tomato, sliced lettuce, and sliced carrots on the yellow rice, then wrapping tightly, and then packaging.

### Example 18

The yellow rice purple roll comprises the following ingredients or having a mass ratio thereof: 80 grams of the yellow rice, 40 grams of sliced cooked salmon, 10 grams of tomato, 10 grams of lettuce, 10 grams of sliced carrots, a piece of purple laver, and two cooked hot dogs, wherein the two hot dogs have a general weight of 4 g. The manufacturing method comprises the following steps of:

1. slicing the cooked salmon into strips, wherein each of the strips is approximately 20 g;

2. placing a piece of the layer on a bamboo matt, then placing the yellow rice on the piece of laver, then placing two pieces of the sliced cooked salmon, two cooked hot dogs, the sliced tomato, the sliced carrots, and the lettuce in the yellow rice and rolling to obtain an elongated strip, and then pressing; and

3. cutting the rolled yellow rice purple roll into six blocks, and then packaging.

### Example 19

The yellow rice tofu skin sushi comprises the following ingredients or having a mass ratio thereof: 20 grams of fried tofu bubble, 15 grams of the yellow rice, 20 grams of sliced meatball containing lobster, 10 grams of sliced tomato, and 10 grams of sliced carrot. The manufacturing method comprises the following steps of:

1. mashing the inner of the fried tofu bubble; and

2. placing the yellow rice into the fried tofu bubble, then putting the yellow rice on the sliced meatball containing lobster, sliced tomato, and sliced carrots on the yellow rice, and then packaging.

### Example 20

The yellow rice sausage comprises the following ingredients or having a mass ratio thereof: 100 mm casing for sausage, 10 grams of vegetable oil, 500 grams of rice, 50 grams of the turmeric curry powder, 1000 grams of water, 100 grams of peanut, 20 grams of small shrimp, 2 grams of salt, and 2 grams of sugar. The manufacturing method comprises the following steps of:

1. adding the turmeric curry powder and 500 grams of water into a pot, then cleaning the rice, and then soaking for 6 hours;

2. cleaning the peanuts, and then adding 250 grams of water to soak for 6 hours;

3. soaking the small shrimp for 10 minutes, and then chopping;

4. cleaning the casings, and then adding 250 grams of water to soak for 2 hours;

5. adding the chopped small shrimp into a pot to fry for 5 minutes, then adding the salt, the sugar, and the soaked rice, and then stirring evenly to obtain the yellow rice stuffing;

6. pouring the vegetable oil into the casings for sausage, and then filling the casings with the yellow rice stuffing forming a yellow rice sausage;

7. putting the yellow rice sausage in the steamer and steaming for 30 minutes; and

8. cutting the yellow rice sausage into yellow rice sausage sushi after removing from the steamer, wherein each of the pieces of the yellow rice sausage sushi is approximately 20 g, and then packaging.

### Example 21

The yellow rice bread roll comprises the following ingredients or having a mass ratio thereof: 100 grams of the yellow rice, 2 pieces of rice bread, 20 grams of sliced cooked hot dog, 10 grams of sliced tomato, 10 grams of lettuce, and 10 grams of sliced carrot, wherein the rice breads have an approximate weight of 50 grams. The manufacturing method comprises the following steps of:

1. flattening the 50 grams of yellow rice;

2. putting the sliced cooked hot dogs in the middle of the flattened yellow rice;

3. flattening another 50 grams of the yellow rice on the flattened yellow rice;

4. pressing with a mold to obtain a roll;

5. placing respectively the sliced tomato, the lettuce, and the sliced carrots on the two rice breads having a weight of 50 grams;

6. placing the roll on one of the two rice breads; and

7. placing another rice bread on the roll, then clamping, and then packaging.

### Example 22

The yellow rice bread egg sushi comprises the following ingredients or having a mass ratio thereof: 20 grams of the yellow rice, 15 grams of sausage, 2 grams of sesame seeds, and 2 grams of crab roe. The manufacturing method comprises the following steps of:

1. cutting the sausage into particles;

2. adding the yellow rice into the mold for egg casings, and then molding and removing the yellow rice; and

3. spreading the pieces of sausage, the sesame seeds, and the crab roe on the yellow rice, and then packaging.

### Example 23

The yellow rice cylindrical pastry cup sushi is comprised a cylindrical pastry cup and comprised of the following ingredients or having a mass ratio thereof: 30 grams of the yellow rice, 20 grams of sausage, 2 grams of sesame seeds, and 2 grams of crab roe. The manufacturing method comprises the following steps of:

1. cutting the sausage;

2. adding the yellow rice into the cylindrical pastry cup; and

3. spreading the cut sausage, the sesame seeds, and the crab roe on the yellow rice, and then packaging.

### Example 24

The yellow rice icing moon cake comprises the following ingredients or having a mass ratio thereof: 50 grams of cooked low-gluten flour, 50 grams of cooked glutinous rice flour, 10 grams of the turmeric curry powder, 40 grams of sugar, 180 grams of milk, 50 grams of condensed milk, and 1400 grams of the yellow rice. The manufacturing method comprises the following steps of:

1. adding the cooked low-gluten flour, the cooked glutinous rice flour, the turmeric curry powder, the sugar, the milk, and the condensed milk into a container, then stirring into a paste, and then steaming for 30 minutes to obtain a rice dough;

2. getting the rice dough out, then cooling to room temperature, and then placing in a 4° C. ice chamber for 2 hours;

3. getting the dough, kneading evenly, then wrapping with plastic wrap, and then stewing for 15 minutes;

4. dividing the dough into blocks, wherein each of blocks is 50 grams, then pressing and rolling into circular casings, and then packaging 70 grams of the yellow rice in the circular casings;

5. molding the dough wrapping with the yellow rice in a cake tin to obtain a yellow rice icing moon cake, then and packaging.

### Example 25

The yellow rice egg yolk moon cake (twenty) comprises the following ingredients or having a mass ratio thereof: 140 grams of cooked low-gluten flour, 40 grams of cream, 53 grams of sugar, 13 grams of milk powder, 20 grams of maltose, 50 grams of egg, 2 grams of salt, 600 grams of the yellow rice, and 200 grams of salted egg yolks (20 eggs in total). The manufacturing method comprises the following steps of:

1. adding the cream and the sugar into a container, and then stirring evenly, and then adding the milk powder and the maltose and stirring evenly;

2. adding the egg yolk at two times and stirring evenly, then adding the salt, and then stirring evenly to obtain an egg paste;

3. sieving the low-gluten flour, then adding the egg paste, and then kneading into a dough;

4. wrapping in plastic wrap, and stewing for 30 minutes to relax the dough;

5. cooking the salted egg yolks;

6. flattening the dough, then packaging 30 grams of the yellow rice in a flattened dough, and then adding a cooked egg yolk in the flattened dough to obtain the moon cake;

7. sprinkling water on the moon cake and transferring it into an oven;

8. firstly, baking for 10 minutes at 250° C., then secondly, baking at 200° C. for 10 minutes, wherein the moon cake is taken out two times during the baking to have egg white painted on the surface; and

9. baking at 250° C. for 5 minutes, then baking at 200° C. for 20 minutes, then removing from the oven and allowing the moon cake to naturally cool, and then packaging.

### Example 26

The yellow rice dumpling comprises the following ingredients or having a mass ratio thereof: 300 grams of glutinous rice, 300 grams of pearl rice, 600 grams of streaky pork, 100 grams of turmeric curry powder, 200 grams of water, 100 grams of fried fish ball, 100 grams of salmon, 100 grams of carrots, 100 grams of beef brisket, 20 dumpling leaves, 1 gram of salt, 1 gram of sugar, and 2 grams of soy sauce. The manufacturing method comprises the following steps of:

1. adding the turmeric curry powder into a pot, then adding water, and then stirring evenly to obtain yellow water;

2. cleaning the glutinous rice and the pearl rice, then adding into the yellow water, and then soaking for 2 hours;

2. getting out of the glutinous rice and the pearl rice and draining;

4. cleaning the streaky pork, and then cutting into strips;

5. frying the fish balls for 5 minutes in 60-70° C. oil, then removing the fish balls from the oil and draining;

6. removing the bones from the salmon and slicing them into small blocks, wherein each of blocks has a weight of approximately 1 gram;

7. slicing the carrot into blocks, wherein each of blocks has the dimensions of 2 mm×2 mm×20 mm;

8. adding the sliced salmons, the sliced streaky pork, the fried fish balls, and the sliced carrots into a container, then adding the salt, the sugar and the soy sauce, then adding the turmeric curry water, and then stirring, salting for 2 hours;

9. heating the dumpling leaves in boiling water for 1 minute;

10. taking two dumpling leaves, folding into a funnel-shaped, and then adding 60 grams of soaked glutinous rice and pearl rice, 60 grams of streaky pork, 10 grams of fried fish balls, 10 grams of beef brisket, 10 grams of salmon, and 10 grams of carrots and packaging to obtain a rice dumpling, and then fastening tightly by a string; and

11. boiling for 4 hours, then allowing the dumplings to naturally cool, and then packaging.

### Example 27

The yellow rice tortoise jelly paste tart comprises the following ingredients or having a mass ratio thereof: 200 grams of flour, 200 grams of eggs (4 eggs), 170 grams of milk, 80 grams of vegetable oil, 70 grams of white sugar, 1 grams of salt, 150 grams of water, 1 gram of vanilla oil, 1 gram of black sesame powder, 1 gram of tortoise shell powder, 1 gram of glabrous greenbrier rhizome powder, 1 gram of grass jelly powder, and 1 gram of the yellow rice. The manufacturing method comprises the following steps of:

1. adding 20 grams of sugar into 25 grams of water to obtain the corresponding syrup;

2. adding the salt, the vegetable oil, and 20 grams of milk, and then stirring evenly;

3. adding the 2 eggs and stirring to obtain the corresponding egg liquid;

4. adding the flour and kneading to obtain the dough;

5. flattening the dough into a round tart casing, then adding into a tart mold, and then compacting;

6. stirring evenly the 2 eggs to obtain the egg liquid, then mixing with 150 grams of milk, then pouring 50 grams of white sugar, 125 grams of water, the black sesame powder, the tortoise shell powder, the glabrous greenbrier rhizome powder, the grass jelly powder, the yellow rice, and the vanilla oil, and then stirring to obtain black egg juice;

7. pouring the black egg juice into the tart mold having an egg tart casing until 90% of the space of the tart mold is filled; and

8. placing in an oven and baking for 20 minutes at 180° C., and then removing and allowing to naturally cool.

### Example 28

The yellow rice fried hot dog roll comprises the following ingredients or having a mass ratio thereof: 30 grams of the yellow rice, 15 grams of cooked hot dog, 10 grams of flour, an egg (50 grams), and 20 grams of flour. The manufacturing method comprises the following steps of:

1. paving the yellow red rice;

2. placing the hot dogs on the yellow rice;

3. kneading the hot dogs on the yellow rice into a round roll;

4. coating the round roll with flour;

5. coating evenly with the egg liquid;

6. lastly, coating evenly with flour one more time; and

7. frying the roll coated with flour and egg liquid in a pot of oil at 180° C. until the surface of the roll is golden brown, then removing from the pot and draining the excess oil, and then packaging.

### Example 29

The black rice comprises the following ingredients or having a mass ratio thereof: 15 grams of the black rice, 20 grams of sliced cooked salmon, 10 grams of tomato, 10 grams of lettuce, 10 grams of sliced carrots, and 2 grams of purple laver. The manufacturing method comprises the following steps of:

1. pressing the black rice into a flat oval shape; and

2. placing the sliced cooked salmon, sliced tomato, sliced lettuce, and sliced carrots on the black rice, then wrapping tightly, and then packaging.

### Example 30

The back rice comprises the following ingredients or having a mass ratio thereof: 15 grams of the black rice, 20 grams of sliced cooked hot dog, 10 grams of sliced tomato, 10 grams of lettuce, 10 grams of sliced carrots, and 2 grams of purple laver. The manufacturing method comprises the following steps of:

1. pressing the black rice into a flat oval shape; and

2. placing the sliced cooked hot dog, sliced tomato, sliced lettuce, and sliced carrots on the black rice orderly, then enveloping tightly, and then packaging.

### Example 31

The black rice purple roll is comprised the following ingredients or having a mass ratio thereof: 80 grams of the black rice, 40 grams of sliced cooked salmon, 10 grams of tomato, 10 grams of lettuce, 10 grams of sliced carrots, a piece of purple laver, and two cooked hot dogs, wherein the two hot dogs have an approximate weight of 40 g. The manufacturing method comprises the following steps of:

1. slicing the cooked salmon into strips, wherein each of the strips is approximately 20 grams;

2. placing the piece of layer on a bamboo mat, then placing the black rice on the piece of laver, then placing two pieces of the sliced cooked salmon, two cooked hot dogs, sliced tomato, sliced carrots and lettuce in the black rice and rolling to obtain an elongated strip, then and pressing; and

3. cutting the rolled black rice purple roll into six blocks, and then packaging.

### Example 32

The black rice tofu skin sushi is comprised the following ingredients or having a mass ratio thereof: 20 grams of fried tofu bubble, 15 grams of the black rice, 20 grams of sliced meatball containing lobster, 10 grams of sliced tomato, and 10 grams of sliced carrot. The manufacturing method comprises the following steps of:

1. mashing the inner area of the fried tofu bubble; and

2. placing the black rice into the fried tofu bubble, then putting the black rice on the sliced meatball containing lobster, sliced tomato, and sliced carrots, and then packaging.

### Example 33

The black rice sausage sushi comprises the following ingredients or having a mass ratio thereof: 100 mm casing for sausage, 10 grams of vegetable oil, 500 grams of rice, 100 grams of black sesame powder, 10 grams of black sesame seeds, 10 grams of tortoise shell powder, 10 grams of glabrous greenbrier rhizome powder, 1200 grams of water, 100 grams of peanut, 20 grams of small shrimp, 2 grams of salt, and 2 grams of sugar. The manufacturing method comprises the following steps of:

1. adding the black sesame powder, the tortoise shell powder, and the glabrous greenbrier rhizome powder in a pot, then boiling in a pot of water, and then filtering;

2. cleaning the rice and soaking it in a pot of the filtered black water for 6 hours;

3. cleaning the peanuts and adding water to soak for 6 hours;

4. soaking the small shrimp in water for 10 minutes, and then chopping;

5. cleaning the casings and adding water to soak for 2 hours;

6. adding the chopped small shrimp into a pot to fry, then adding the salt, sugar, soaked rice, and then stirring evenly to obtain the black rice stuffing;

7. pouring the vegetable oil into the casings for sausage, and then filling the casings with the yellow rice stuffing;

8. putting the black rice sausage in the steamer and steaming for 30 minutes;

9. cutting the black rice sausage into black rice sausage sushi after removing the black rice sausage, wherein each of pieces of the black rice sausage sushi is approximately 20 g, and then packaging.

### Example 34

The black rice bread roll comprises the following ingredients or having a mass ratio thereof: 100 grams of the black rice, 2 pieces of rice bread, 20 grams of sliced cooked hot dog, 10 grams of sliced tomato, 10 grams of lettuce, and 10 grams of sliced carrot, wherein the rice breads have an approximate weight of 50 grams. The manufacturing method comprises the following steps of:

1. flattening 50 grams of the black rice;

2. putting the cooked hot dogs in the middle of the flattened black rice, and then flattening another 50 grams of the black rice on the flattened black rice;

4. pressing in a mold to obtain a roll;

5. placing respectively the sliced tomato, lettuce, and sliced carrots on the two rice breads;

6. placing the roll on one of the two rice breads; and

7. placing another rice bread on the roll, then clamping, and then packaging.

### Example 35

The black rice bread egg sushi comprises the following ingredients or having a mass ratio thereof: 20 grams of the black rice, 15 grams of sausage, 2 grams of sesame seeds, and 2 grams of crab roe. The manufacturing method comprises the following steps of:

1. cutting the sausage into pieces;

2. adding the black rice into the mold for egg casings, and molding and getting out of the black rice;

3. spreading the pieces of sausage, the sesame seeds, and the crab roe on the black rice, and then packaging.

### Example 36

The black rice cylindrical pastry cup sushi comprises a cylindrical pasty cup which is comprised o the following ingredients or having a mass ratio thereof: 30 grams of the black rice, 20 grams of sausage, 2 grams of sesame, and 2 grams of crab roe. The manufacturing method comprises the following steps of:

1. Cutting the sausage;

2. adding the black rice into the cylindrical pastry cup;

3. spreading the cut sausage, the sesame seeds, and the crab roe on the black rice, and then packaging.

### Example 37

The black rice icing moon cake comprises the following ingredients or having a mass ratio thereof: 50 grams of cooked low-gluten flour, 50 grams of cooked glutinous rice flour, 10 grams of the black sesame powder, 10 grams of tortoise shell powder, 10 grams of glabrous greenbrier rhizome, 40 grams of sugar, 180 grams of milk, 50 grams of condensed milk, and 1400 grams of the black rice. The manufacturing method comprises the following steps of:

1. adding the cooked low-gluten flour, the cooked glutinous rice flour, the black sesame powder, the tortoise shell powder, the glabrous greenbrier rhizome, the sugar, the milk, and the condensed milk into a container, then stirring it to a paste, and then steaming for 30 minutes to obtain a rice dough;

2. getting the rice dough out, then cooling it to room temperature, and then placing in a 4° C. ice chamber for 2 hours;

3. getting the dough, kneading evenly, then wrapping with plastic wrap, and then stewing for 15 minutes;

4. dividing the dough into blocks, wherein each of blocks is 50 grams, then pressing and rolling into a circular casing, and then packaging 70 grams of the black rice in the circular casing; and

5. molding the dough wrapping with the black rice in a cake tin to obtain a black rice icing moon cake, and then packaging.

### Example 38

The black rice egg yolk moon cake comprises the following ingredients or having a mass ratio thereof: 140 grams of cooked low-gluten flour, 40 grams of cream, 53 grams of sugar, 13 grams of milk powder, 20 grams of maltose, 40 grams of egg, 2 grams of salt, 600 grams of the black rice, and 200 grams of salted egg yolks which are about 20 eggs. The manufacturing method comprises the following steps of:

1. adding the cream the sugar, milk powder, and maltose into a container, and then stirring evenly;

2. adding the egg yolks two at a time and stirring evenly, and then adding the salt and stirring evenly to obtain an egg paste;

3. sieving the low-gluten flour and adding the egg paste, and then kneading it into a dough;

4. wrapping with plastic wrap and letting the dough rest for 30 minutes;

5. cooking the salted egg yolks;

6. flattening the dough, then packaging 30 grams of the black rice in the flattened dough, and then adding a cooked egg yolk to the flattened dough to obtain the moon cake;

7. sprinkling water on the moon cake and transferring it to an oven;

8. first, baking for 10 minutes at 250° C., and baking a second time at 200° C. for 10 minutes, all the while taking out the moon cake and painting egg whites on the top two times during the baking; and

9. baking at 250° C. for 5 minutes, then baking at 200° C. for 20 minutes, then removing from the oven and allowing the moon cake to cool naturally, and then packaging.

### Example 39

The black rice dumpling is comprised the following ingredients or having a mass ratio thereof: 300 grams of glutinous rice, 300 grams of pearl rice, 600 grams of streaky pork, 100 grams of black sesame powder, 20 grams of tortoise shell powder, 20 grams of glabrous greenbrier rhizome, 20 grams of black sesame seeds, 1000 grams of water, 100 grams of chicken, 20 dumpling leaves, 1 gram of salt, 1 gram of sugar, and 2 grams of soy sauce. The manufacturing method comprises the following steps of:

1. adding the black sesame powder, the tortoise shell powder, the glabrous greenbrier rhizome, and the black sesame into a pot, and then adding water and stirring evenly to obtain the black water;

2. cleaning 300 grams of the glutinous rice and 300 grams of the pearl rice, and then adding them into the black water to soak for 2 hours;

3. removing the glutinous rice and the pearl rice from the black water and draining;

4. cleaning the streaky pork, and then cutting it into strips;

5. cutting the chicken into blocks;

6. adding the streaky pork and the chicken into a container, then adding the salt, the sugar, and the soy sauce, and then stirring and salting for 2 hours;

7. heating the dumpling leaves in boiling water for 1 minute;

8. taking two dumpling leaves and folding them into a funnel-shaped, then adding 60 grams of soaked glutinous rice and pearl rice, 60 grams of streaky pork, 10 grams of chicken and forming the dumpling leaves to obtain a rice dumpling, and then fastening tightly by a string; and

8. boiling for 4 hours, and then allowing them to naturally cool, and then packaging.

### Example 40

The black rice tortoise jelly paste tart comprises the following ingredients or having a mass ratio thereof: 200 grams of flour, 200 grams of eggs (4 eggs), 170 grams of milk, 80 grams of vegetable oil, 70 grams of white sugar, 1 gram of salt, 150 grams of water, 1 gram of vanilla oil, 1 gram of black sesame powder, 1 gram of tortoise shell powder, 1 gram of glabrous greenbrier rhizome powder, 1 gram of grass jelly powder, and 1 gram of the black rice. The manufacturing method comprises the following steps of:

1. adding 25 grams of water to 20 grams of sugar and stirring evenly to obtain the an amount of syrup;

2. adding the salt, the vegetable oil, and 20 grams of milk and then stirring evenly;

3. adding 1 egg and stirring to obtain an amount of egg liquid;

4. adding the flour and kneading to obtain a dough;

5. flattening the dough into a round tart casing, and then adding it into a tart mold and compressing;

6. stirring 2 eggs to obtain an egg liquid, then mixing the egg liquid with 150 grams of milk, and then pouring 50 grams of sugar, 125 grams of water, the black sesame powder, the tortoise shell powder, the glabrous greenbrier rhizome powder, the grass jelly powder, the black rice, and the vanilla oil and stirring to obtain the black egg juice;

7. pouring the black egg juice into the tart mold having an egg tart casing until 90% of the space of the tart mold is filled; and

8. placing the tart in an oven and baking for 20 minutes at 180° C., and then removing and allowing to naturally cool

### Example 41

The black rice fried hot dog roll comprises the following ingredients or having a mass ratio thereof: 30 grams of the black rice, 15 grams of cooked hot dog, 10 grams of flour, an egg, and 20 grams of flour. The manufacturing method comprises the following steps of:

1. paving 30 grams of the black rice;

2. placing the hot dogs on the black rice;

3. kneading the black rice and hot dog into a round roll;

4. coating the round roll with flour;

5. coating the round roll evenly with egg liquid;

6. coating evenly with flour again; and

7. frying the roll coated with flour and egg liquid at 180° C. in a pot of oil until the surface of the roll is golden brown, then removing the roll from the oil and draining the excess oil, and then packaging.

### Example 42

The white rice comprises the following ingredients or having a mass ratio thereof: 15 grams of the white rice, 20 grams of sliced cooked salmon, 10 grams of tomato, 10 grams of lettuce, 10 grams of sliced carrots, and two grams of purple laver. The manufacturing method comprises the following steps of:

1. pressing the white rice to have a flat oval shape; and

2. placing the sliced cooked salmon, the sliced tomato, the sliced lettuce, and the sliced carrots on the white rice, then wrapping tightly, and then packaging.

### Example 43

The white rice comprises the following ingredients or having a mass ratio thereof: 15 grams of the white rice, 20 grams of sliced cooked hot dog, 10 Grams of sliced tomato, 10 grams of lettuce, 10 grams of sliced carrots, and 2 grams of purple laver. The manufacturing method comprises the following steps of:

1. pressing the white rice into a flat oval shape; and

2. placing the sliced cooked hot dog, the sliced tomato, the sliced lettuce, and the sliced carrots on the white rice orderly, then wrapping tightly, and then packaging.

### Example 44

The white rice purple roll comprises the following ingredients or having a mass ratio thereof: 80 grams of the white rice, 40 grams of sliced cooked salmon, 10 grams of tomato, 10 grams of lettuce, 10 grams of sliced carrots, a piece of purple laver, and two cooked hot dogs, wherein the two hot dogs have an approximate weight of 40 g. The manufacturing method comprises the following steps of:

1. slicing the cooked salmon into strips, wherein each of strips is approximately 20 g;

2. placing the piece of layer on a bamboo mat, then placing the white rice on the piece of laver, then placing the two pieces of sliced cooked salmon, two cooked hot dogs, the sliced tomato, the sliced carrots, and the lettuce in the white rice and rolling to obtain an elongated strip, and then pressing; and

3. cutting the rolled white rice purple roll into six blocks, and then packaging.

### Example 45

The white rice tofu skin sushi contains comprises the following ingredients or having a mass ratio thereof: 20 grams of fried tofu bubble, 15 grams of the white rice, 20 grams of sliced meatball containing lobster, 10 grams of sliced tomato, and 10 grams of sliced carrot. The manufacturing method comprises the following steps of:

1. mashing the inner of the fried tofu bubble; and

2. placing the white rice into the fried tofu bubble, then putting the sliced meatball containing lobster, sliced tomato and sliced carrots on the white rice, and then packaging.

### Example 46

The white rice sausage sushi comprises the following ingredients or having a mass ratio thereof: 100 mm of casing for sausage, 10 grams of vegetable oil, 500 grams of rice, 100 grams of copra, 20 grams of coconut powder, 1120 grams of water, 100 grams of peanut, 20 grams of small shrimp, 2 grams of salt, and 2 grams of sugar. The manufacturing method comprises the following steps of:

1. adding the copra into water, then stirring with a blender, then filtering and obtaining the copra juice, then cleaning the rice, and then adding the copra juice to soak for 6 hours;

2. cleaning the peanuts and adding them into the water to soak for 6 hours;

3. soaking the small shrimp for 10 minutes in the water, and then chopping;

4. cleaning the casings, then adding then into water to soak for 2 hours;

5. adding the chopped small shrimp into a pot to fry for 5 minutes, then adding the coconut powder, the salt, the sugar, and the soaked rice, and then stirring evenly to obtain the white rice stuffing;

6. pouring the vegetable oil into the casings for sausage, and then filling the casings with white rice stuffing;

7. putting the white rice sausage in the steamer to steam for 30 minutes; and

8. cutting the yellow rice sausage into yellow rice sausage sushi after getting out of the white rice sausage, wherein each of pieces of the yellow rice sausage sushi is 20 g, and packaging.

### Example 47

The white rice bread roll comprises the following ingredients or having a mass ratio thereof: 100 grams of the white rice, 2 pieces of rice bread, 20 grams of sliced cooked hot dog, 10 grams of sliced tomato, 10 grams of lettuce, and 10 grams of sliced carrot, wherein the rice breads have a general weight of 50 grams each. The manufacturing method comprises the following steps of:

1. flattening 50 grams of the white rice;

2. putting the cooked hot dogs in the middle of the flattened white rice, and then flattening another 50 grams of the white rice on the previously flattened white rice;

4. pressing with a mold to obtain a roll;

5. placing the sliced tomato, the lettuce, and the sliced carrots on the two rice breads;

6. placing the roll on one of the two rice breads; and

7. placing the other rice bread on the roll, then pressing the two pieces of rice bread together, and then packaging.

### Example 48

The white rice bread egg sushi comprises the following ingredients or having a mass ratio thereof: 20 grams of the white rice, 15 grams of sausage, 2 grams of sesame seeds, and 2 grams of crab roe. The manufacturing method comprises the following steps of:

1. cutting the sausage into pieces;

2. adding the white rice into the mold for egg casings, and then molding and removing the white rice;

3. spreading the pieces of sausage, the sesame seeds, and the crab roe on the white rice, and then packaging.

### Example 49

The white rice cylindrical pastry cup sushi comprises a cylindrical pasty cup which comprises the following ingredients or having a mass ratio thereof: 30 grams of white rice, 20 grams of sausage, 2 grams of sesame seeds, and 2 grams of crab roe. The manufacturing method comprises the following steps of:

1. cutting the sausage;

2. adding the white rice into the cylindrical pastry cup; and

3. spreading the cut sausage, the sesames, and the crab roe on the white rice, and then packaging.

### Example 50

The white rice icing moon cake comprises the following ingredients or having a mass ratio thereof: 50 grams of cooked low-gluten flour, 50 grams of cooked glutinous rice flour, 10 grams of the copra powder, 40 grams of sugar, 180 grams of milk, 50 grams of condensed milk, 50 grams, and 1400 grams of the white rice. The manufacturing method comprises the following steps of:

1. adding the cooked low-gluten flour, the cooked glutinous rice flour, the copra powder, the sugar, the milk, and the condensed milk into a container, then stirring to a paste, and then steaming for 30 minutes to obtain a rice dough;

2. removing the rice dough, then allowing it to cool to room temperature, and then placing in a 4° C. ice chamber for 2 hours;

3. getting the dough, kneading evenly and wrapping with a plastic wrap, and then stewing for 15 minutes;

4. dividing the dough into blocks, wherein each block weighs approximately 50 grams, then pressing and rolling into a circular casing, and then packaging 70 grams of the white rice with the circular casing; and

5. molding the dough wrapping with the white rice in a cake tin to obtain a white rice icing moon cake, and then packaging.

### Example 51

The white rice egg yolk moon cake comprises the following ingredients or having a mass ratio thereof: 140 grams of cooked low-gluten flour, 40 grams of cream, 53 grams of sugar, 13 grams of milk powder, 20 grams of maltose, 40 grams of egg, 2 grams of salt, 600 grams of the white rice, and 200 grams of salted egg yolks which is about 20 eggs. The manufacturing method comprises the following steps of:

1. adding the cream, the milk powder, the maltose, and the sugar into a container and stirring evenly;

2. adding the egg yolk two at a time and stirring evenly, and then adding the salt and stirring evenly to obtain an egg paste;

3. sieving the low-gluten flour, then adding the egg paste, and then kneading it into a dough;

4. wrapping the dough with plastic wrap, and then stewing for 30 minutes to relax the dough;

5. cooking the salted egg yolks;

6. flattening the dough, then packaging 30 grams of the white rice on the flattened dough, and then adding a cooked egg yolk in the flattened dough to obtain the moon cake;

7. sprinkling water on the moon cake and transferring it into an oven;

8. first, baking for 10 minutes at 250° C., then second, baking at 200° C. for 10 minutes, all the while removing the moon cake twice during this baking to paint egg whites on top; and

9. baking at 250° C. for 5 minutes, then baking at 200° C. for 20 minutes, then removing from the oven and allowing the cake to cool naturally, and then packaging.

### Example 52

The white rice dumpling comprises the following ingredients or having a mass ratio thereof: 300 grams of glutinous rice, 300 grams of pearl rice, 600 grams of streaky pork, 300 grams of pork hand, 100 grams of pigskin, 500 grams of eggs (10 eggs), 100 grams of peanuts, 10 grams of ginger, 3 grams of white sugar, 3 grams of salt, 20 grams of glutinous sweet vinegar, 20 dumpling leaves, and 1 gram of soy sauce. The manufacturing method comprises the following steps of:

1. cleaning the glutinous rice and the pearl rice with water, and then soaking for 2 hours in the water;

2. removing the glutinous rice and the pearl rice from the water and draining;

3. adding the glutinous rice and the pearl rice into a container, and then stirring repeatedly and evenly;

4. cleaning the streaky pork, and then cutting it into strips;

5. cutting the pork hand into blocks, wherein each of the blocks is a cubic centimeter in dimensions;

6. cutting the pigskin into blocks, wherein each of blocks has an area of 1 cm×1 cm;

7. boiling the eggs and removing the shells from the cooked eggs;

8. adding the ginger, the glutinous sweet vinegar, the white sugar, and the salt to the streaky pork, the pork hand, the pigskin and the shelled eggs, then stirring evenly, and then salting for 2 hours;

9. heating the dumpling leaves in boiling water for about 1 minute;

10. taking two dumpling leaves and folding them into a funnel-shape, then adding 60 grams of soaked glutinous rice and pearl rice, 60 grams of streaky pork, 30 grams of pork hand, 10 grams of pigskin, 1 egg, and one piece of ginger, then forming to obtain a rice dumpling, and then fastening tightly by a string; and

11. boiling for 4 hours, then allowing to naturally cool, and then packaging.

### Example 53

The white rice tortoise jelly paste tart comprises the following ingredients or having a mass ratio thereof: 200 grams of flour, 200 grams of eggs (2 eggs), 170 grams of milk, 80 grams of vegetable oil, 70 grams of sugar, 1 gram of salt, 150 grams of water, 1 gram of vanilla oil, 1 gram of black sesame powder, 1 gram of tortoise shell powder, 1 gram of glabrous greenbrier rhizome, 1 gram of grass jelly, and 1 gram of the white rice. The manufacturing method comprises the following steps of:

1. adding 20 grams of sugar into 25 grams of water and melting to obtain an amount of syrup;

2. adding the salt, the vegetable oil, and 20 grams of milk and stirring evenly;

3. adding 200 grams eggs and stirring to obtain the corresponding egg liquid; and

4. adding the flour and kneading to obtain a dough.

5. flattening the dough into a round tart casing, then adding it into a tart mold and then compacting;

6. stirring the 2 eggs evenly 2 eggs to obtain an egg liquid, then mixing with 150 grams of milk, then pouring 50 grams of white sugar, 125 grams of water, the black sesame powder, the tortoise shell powder, the glabrous greenbrier rhizome powder, the grass jelly powder, the white rice, and the vanilla oil and stirring to obtain the black egg juice;

7. pouring the black egg juice into the tart mold having an egg tart casing until 90% of the space of the tart mold is filled;

8. placing the black egg juice tart in an oven and baking for 20 minutes at 180° C., and then removing it from the oven and allowing it to naturally cool.

### Example 54

The white rice fried hot dog roll comprises the following ingredients or having a mass ratio thereof: 30 grams of the white rice, 15 grams of cooked hot dog, 10 grams of flour, an egg, and 20 grams of flour. The manufacturing method comprises the following steps of:

1. paving the white rice;

2. placing the hot dogs among the white rice;

3. kneading into a round roll;

4. coating with flour;

5. coating evenly with the egg liquid;

6. lastly, coating evenly with flour; and

7. frying the roll coated with flour and egg liquid at 180° C. in an oil pot until the surface of the roll is golden brown, then getting out and draining, and then packaging.

### Example 55

The orange rice comprises the following ingredients or having a mass ratio thereof: 15 grams of the orange rice, 20 grams of sliced cooked salmon, 10 grams of tomato, 10 grams of lettuce, 10 grams of sliced carrots, and 2 grams of purple laver. The manufacturing method comprises the following steps of:

1. pressing the orange rice into a flat oval shape; and

2. placing the sliced cooked salmon, sliced tomato, sliced lettuce and sliced carrots on the orange rice, then wrapping tightly, and then packaging.

### Example 56

The orange rice comprises the following ingredients or having a mass ratio thereof: 15 grams of the orange rice, 20 grams of sliced cooked hot dog, 10 grams of sliced tomato, 10 grams of lettuce, 10 grams of sliced carrots, and 2 grams of purple laver. The manufacturing method comprises the following steps of:

1. pressing the orange rice into a flat oval shape; and

2. placing the sliced cooked hot dog, the sliced tomato, the sliced lettuce, and the sliced carrots on the orange rice, then wrapping tightly, and then packaging.

### Example 57

The orange rice purple roll comprises the following ingredients or having a mass ratio thereof: 80 grams of the orange rice, 40 grams of sliced cooked salmon, 10 grams of tomato, 10 grams of lettuce, 10 grams of sliced carrots, a piece of purple laver, and two cooked hot dogs, wherein the two hot dogs have a general weight of approximately 40 g. The manufacturing method comprises the following steps of:

1. slicing the cooked salmon into strips, wherein each of the strips is 20 g;

2. placing the piece of layer on a bamboo mat, then placing the orange rice on the piece of laver, then placing two piece of the sliced cooked salmon, two cooked hot dogs, the sliced tomato, the sliced carrots, and the lettuce on the orange rice and rolling to obtain an elongated strip, and then pressing; and

3. cutting the rolled orange rice purple roll into six blocks, and packaging.

### Example 58

The orange rice tofu skin sushi comprises the following ingredients or having a mass ratio thereof: 20 grams of fried tofu bubble, 15 grams of the orange rice, 20 grams of sliced meatball containing lobster, 10 grams of sliced tomato, and 10 grams of sliced carrot. The manufacturing method comprises the following steps of:

1. mashing the inner of the fried tofu bubble; and

2. placing the orange rice into the fried tofu bubble, then putting the sliced meatball containing lobster, sliced tomato, and sliced carrots on the orange rice, and then packaging.

### Example 59

The orange rice sausage sushi comprises the following ingredients or having a mass ratio thereof: 100 mm casing for sausage, 10 grams of vegetable oil, 500 grams of rice, 100 grams of carrots, 20 grams of carrots powder, 1120 grams of water, 100 grams of peanut, 20 grams of small shrimp, 2 grams of salt, and 2 grams of sugar. The manufacturing method comprises the following steps of:

1. adding the carrot into the water and blending, then filtering and obtaining the carrot juice, then cleaning the rice, and then adding the carrot juice to soak for 6 hours;

3. cleaning the peanuts and adding them into water to soak for 6 hours;

4. soaking the small shrimp for 10 minutes in water, and then chopping;

5. cleaning the casings, then adding them into the water to soak for 2 hours;

6. adding the chopped small shrimp into a pot to fry for 5 minutes, then adding the carrot powder, the salt, the white sugar, and the soaked rice, and then stirring evenly to obtain the orange rice stuffing;

7. pouring the vegetable oil into the casings for sausage, and then filling the casings with the orange rice stuffing;

8. putting the orange rice sausage in the steamer to steam for 30 minutes; and

9. cutting the orange rice sausage into orange rice sausage sushi after removing the orange rice sausage from the steamer, wherein each of the pieces of the orange rice sausage sushi is approximately 20 g, and then packaging.

### Example 60

The red rice bread roll comprises the following ingredients or having a mass ratio thereof: 100 grams of orange rice, 2 pieces of rice bread, 20 grams of sliced cooked hot dog, 10 grams of sliced tomato, 10 grams of lettuce, and 10 grams of sliced carrot. The manufacturing method comprises the following steps of:

1. flattening 50 grams of the orange rice;

2. putting the sliced cooked hot dogs in the middle of the flattened orange rice;

3. flattening another 50 grams of the orange rice on the previously flattened yellow rice;

4. pressing with a mold to obtain a roll;

5. placing the sliced tomato, lettuce, and sliced carrots respectively on the two rice breads each having a weight of approximately 50 grams;

6. placing the roll on one of the two rice breads; and

7. placing the other rice bread on the roll, then clamping tightly with another piece of rice bread, and then packaging.

### Example 61

The orange rice bread egg sushi comprises the following ingredients or having a mass ratio thereof: 20 grams of the orange rice, 15 grams of sausage, 2 grams of sesame, and 2 grams of crab roe. The manufacturing method comprises the following steps of:

1. cutting the sausage into pieces;

2. adding the orange rice into the mold for the egg casings, and then molding and removing the orange rice; and

3. spreading the pieces of the sausage, the sesames, and the crab roe on the orange rice, and then packaging.

### Example 62

The orange rice cylindrical pastry cup sushi comprises a

cylindrical pastry cup which comprises the following ingredients or having a mass ratio thereof: 30 grams of orange rice, 20 grams of sausage, 2 grams of sesame seeds, and 2 grams of crab roe. The manufacturing method comprises the following steps of:

1. cutting the sausage;

2. adding the orange rice into the cylindrical pastry cup; and

3. spreading the cut sausage, the sesames seeds, and the crab roe on the orange rice, and then packaging.

### Example 63

The orange rice icing moon cake comprises the following ingredients or having a mass ratio thereof: 50 grams of cooked low-gluten flour, 50 grams of cooked glutinous rice flour, 10 grams of the carrot powder, 40 grams of white sugar, 180 grams of milk, 50 grams of condensed milk, 50 grams, and 1400 grams of the orange rice. The manufacturing method comprises the following steps of:

1. adding the cooked low-gluten flour, the cooked glutinous rice flour, the carrot powder, the white sugar, the milk, and the condensed milk into a container, then stirring to a paste, and then steaming for 30 minutes to obtain a rice dough;

2. removing the rice dough, then allowing it to cool to room temperature, and then placing it in a 4° C. ice chamber for 2 hours;

3. getting the dough, kneading evenly and wrapping with a plastic wrap, and then stewing for 15 minutes;

4. dividing the dough into blocks, wherein each of blocks is approximately 50 grams, then pressing and rolling it into a circular casing, and then packaging 70 grams the circular casing with the orange rice; and

5. molding the dough wrapping with the orange rice into a cake tin to obtain a orange rice icing moon cake, and then packaging.

### Example 64

The orange rice egg yolk moon cake comprises the following ingredients or having a mass ratio thereof: 140 grams of cooked low-gluten flour, 40 grams of cream, 53 grams of sugar, 13 grams of milk powder, 20 grams of maltose, 50 grams of egg, 2 grams of salt, 600 grams of orange rice, and 200 salted egg yolks which are approximately 20 eggs. The manufacturing method comprises the following steps of:

1. adding the cream, the milk powder, the maltose, and the sugar into a container, and then stirring evenly;

2. adding the egg yolks two at a time and stirring evenly, and then adding the salt and stirring evenly to obtain an egg paste;

3. sieving the low-gluten flour and adding the egg paste, and then kneading into a dough;

4. wrapping with a plastic wrap, then stewing for 30 minutes, and then allowing the dough to relax;

5. cooking the salted egg yolks;

6. flattening the dough, then packaging 30 grams of the orange rice in a flattened dough, and then adding a cooked egg yolk in the flattened dough to obtain the moon cake;

7. sprinkling water on the moon cake and transferring it into an oven;

8. first, baking the moon cake for 10 minutes at 250° C., and second, baking at 200° C. for 10 minutes; all the while painting egg whites on the top of the moon cake twice during baking; and

9. baking at 250° C. for 5 minutes, then baking at 200° C. for 20 minutes, then removing from the oven and allowing it to cool naturally, and then packaging.

### Example 65

The orange rice dumpling comprises the following ingredients or having a mass ratio thereof: 300 grams of glutinous rice, 300 grams of pearl rice, 600 grams of streaky pork, 100 grams of chicken, 200 grams of water, 100 grams of corn kernel, 100 grams of dried scallops, 100 grams of carrots, 100 grams of copra powder, 20 dumpling leaves, 1 gram of salt, 1 gram of sugar, and 1 grams of soy sauce. The manufacturing method comprises the following steps of:

1. cutting 80 grams of the carrots into blocks, then adding them into a blender and adding water, and then mashing to obtain the carrot juice;

2. cleaning the glutinous rice and the pearl rice by water, and then adding the carrot juice to soak for 2 hours;

3. removing the glutinous rice and the pearl rice and draining;

4. cleaning the streaky pork, and then cutting it into strips;

5. cutting 20 grams of the carrots into blocks;

6. cutting the chicken into blocks;

7. adding the streaky pork, the carrot, the chicken, the corn kernels, the dried scallops, then adding the copra powder, the white sugar, and the salt, and then stirring evenly and salting for 2 hours;

8. heating the dumpling leaves in boiling water for 1 minute;

9. taking two dumpling leaves and folding them into a funnel-shape, then adding 60 grams of soaked glutinous rice and pearl rice, 60 grams of streaky pork, 10 grams of chicken, 10 grams of carrots, 10 grams of dried scallops, and 10 grams of corn kernels, then forming to obtain a rice dumpling, and then fastening tightly by a string; and

10. boiling for 4 hours, then allowing them to naturally cool, and then packaging the dumpling leaves.

### Example 66

The orange rice tortoise jelly paste tart comprises the following ingredients or having a mass ratio thereof: 200 grams of flour, 200 grams of eggs (4 eggs), 170 grams of milk, 80 grams of vegetable oil, 70 grams of white sugar, 1 grams of salt, 150 grams of water, 1 gram of vanilla oil, 1 gram of black sesame powder, 1 gram of tortoise shell powder, 1 gram of glabrous greenbrier rhizome powder, 1 gram of grass jelly powder, and 1 gram of the orange rice. The manufacturing method comprises the following steps of:

1. adding 20 grams of sugar into 25 grams of water to obtain an amount of syrup;

2. adding the salt, the vegetable oil, and 20 grams of milk and stirring evenly;

3. adding the 2 eggs and stirring to obtain the corresponding egg liquid;

4. adding the flour and kneading to obtain a dough;

5. flattening the dough into a round tart casing, and then adding it into a tart mold and compacting;

6. stirring evenly the 2 eggs to obtain an egg liquid, then mixing it with 150 grams of milk, then pouring in 50 grams of white sugar, 125 grams of water, the black sesame powder, the tortoise shell powder, the glabrous greenbrier rhizome powder, the grass jelly powder, the white rice, and the vanilla oil, and then stirring to obtain the black egg juice;

7. pouring the black egg juice into the tart mold having an egg tart casing until 90% of the space of the tart mold is filled; and

8. placing in an oven and baking for 20 minutes at 180° C., and then removing and allowing it to naturally cool.

### Example 67

The orange rice fried hot dog roll contains comprises the following ingredients or having a mass ratio thereof: 30 grams of the orange rice, 15 grams of cooked hot dog, 10 grams of flour, an egg, and 20 grams of flour. The manufacturing method comprises the following steps of:

1. paving the orange rice;

2. placing the hot dogs among the orange rice;

3. kneading it into a round roll;

4. coating with flour;

5. coating evenly with the egg liquid;

6. lastly, coating it evenly with flour, and

7. frying the roll coated with flour and egg liquid at 180° C. in a pot of oil until the surface of the roll is golden brown, and then removing it from the pot and draining the excess oil, and then packaging.

### Example 68

The green rice comprises the following ingredients or having a mass ratio thereof: 15 grams of the green rice, 20 grams of sliced cooked salmon, 10 grams of tomato, 10 grams of lettuce, 10 grams of sliced carrots, and two grams of purple laver. The manufacturing method comprises the following steps of:

1. Pressing the green rice to have a flat oval shape; and

2. Placing sliced cooked salmon, sliced tomato, sliced lettuce and sliced carrots on the green rice, and then enveloping tightly, and then packaging.

### Example 69

The green rice comprises the following ingredients or having a mass ratio thereof: 15 grams of the green rice, 20 grams of sliced cooked hot dog, 10 grams of sliced tomato, 10 grams of lettuce, 10 grams of sliced carrot, and 2 grams of purple laver. The manufacturing method comprises the following steps of:

1. pressing the green rice into a flat oval shape; and

2. placing the sliced cooked hot dog, sliced tomato, sliced lettuce, and sliced carrot on the green rice orderly, and then wrapping tightly, and then packaging.

### Example 70

The green rice purple roll comprises the following ingredients or having a mass ratio thereof: 80 grams of the green rice, 40 grams of sliced cooked salmon, 10 grams of tomato, 10 grams of lettuce, 10 grams of sliced carrots 1 gram of purple layer (1 piece), and two cooked hot dogs, wherein the two hot dogs have a general weight of approximately 40 grams. The manufacturing method comprises the following steps of:

1. slicing the cooked salmon into strips, wherein each of strips is 20 g;

2. placing the piece of layer on a bamboo mat, then placing the green rice on the piece of laver, then placing the two pieces of sliced cooked salmon, two cooked hot dogs, the sliced tomato, the sliced carrot, and the lettuce on the green rice and rolling to obtain an elongated strip, and then pressing; and

3. cutting the rolled green rice purple roll into six blocks, and then packaging.

### Example 71

The green rice tofu skin sushi is comprised the following ingredients or having a mass ratio thereof: 20 grams of fried tofu bubble, 15 grams of the green rice, 20 grams of sliced meatball containing lobster, 10 grams of sliced tomato, and 10 grams of sliced carrots. The manufacturing method comprises the following steps of:

1. Mashing the inner of the fried tofu bubble; and

2. placing the green rice into the fried tofu bubble, then putting the sliced meatball containing lobster, the sliced tomato, and the sliced carrot on the green rice, and then packaging.

### Example 72

The green rice sausage sushi is comprised the following ingredients or having a mass ratio thereof: 100 mm casing for sausage, 10 grams of vegetable oil, 500 grams of rice, 100 grams of spinach, 20 grams of spinach powder, 1500 grams of water, 100 grams of peanut, 20 grams of small shrimp, 2 grams of salt, and 2 grams of sugar. The manufacturing method comprises the following steps of:

1. adding the spinach into water and blending, then filtering the water and obtaining the spinach juice, and then cleaning the rice and adding it into the spinach juice to soak for 6 hours;

3. cleaning the peanuts and adding them into water to soak for 6 hours;

4. soaking the small shrimp for 10 minutes in water, and then chopping;

5. cleaning the casings, and then adding them into water to soak for 2 hours;

6. adding the chopped small shrimp into a pot to fry for 5 minutes, then adding the spinach powder, the salt, the sugar, the soaked rice, and then stirring evenly to obtain the green rice stuffing;

7. pouring the vegetable oil into the casings for the sausage, and then filling the casings with the green rice stuffing;

8. putting the green rice sausage in the steamer to steam for 30 minutes; and

9. cutting the green rice sausage into green rice sausage sushi after removing the green rice sausage from the steamer, wherein each of the pieces of the green rice sausage sushi is approximately 20 grams, and then packaging.

### Example 73

The green rice bread roll is comprised the following ingredients or having a mass ratio thereof: 100 grams of the green rice, 2 pieces of rice bread, 20 grams of sliced cooked hot dog, 10 grams of sliced tomato, 10 grams of lettuce, and 10 grams of sliced carrot, wherein the rice breads have an approximate weight of 50 grams. The manufacturing method comprises the following steps of:

1. flattening 50 grams of the green rice;

2. putting the sliced cooked hot dogs in the middle of the flattened green rice;

3. flattening another 50 grams of the green rice on the previously flattened green rice;

4. pressing by a mold to obtain a roll;

5. placing the sliced tomato, lettuce and the sliced carrot on one of the two rice breads each of which having a weight of 50 grams;

6. placing the roll on one of the two rice breads; and

7. placing the other rice bread on the roll, then clamping tightly, and then packaging.

### Example 74

The green rice bread egg sushi is comprised the following ingredients or having a mass ratio thereof: 20 grams of green rice, 15 grams of sausage, 2 grams of sesame, and 2 grams of crab roe. The manufacturing method comprises the following steps of:

1. cutting the sausage into pieces;

2. adding the green rice into the mold for egg casings, and then molding and removing the green rice;

3. spreading the pieces of sausage, the sesame seeds, and the crab roe on the green rice, and then packaging.

### Example 75

The green rice cylindrical pastry cup sushi comprises a cylindrical

pastry cup and comprises the following ingredients or having a mass ratio thereof: 30 grams of green rice, 20 grams of sausage, 2 grams of sesame seeds, and 2 grams of crab roe. The manufacturing method comprises the following steps of:

1. cutting the sausage;

2. adding the green rice into the cylindrical pastry cup;

3. spreading the cut sausage, the sesame seeds, and the crab roe on the green rice, and then packaging.

### Example 76

The green rice icing moon cake is comprised the following ingredients or having a mass ratio thereof: 50 grams of cooked low-gluten flour, 50 grams of cooked glutinous rice flour, 10 grams of green tea powder, 40 grams of white sugar, 180 grams of milk, 50 grams of condensed milk, 50 grams, and 1400 grams of the green rice. The manufacturing method comprises the following steps of:

1. adding the cooked low-gluten flour, the cooked glutinous rice flour, the green tea powder, the white sugar, the milk, and the condensed milk into a container, then stirring it to a paste, and then steaming for 30 minutes to obtain a rice dough;

2. removing the rice dough, then allowing it to cool to room temperature, and then placing it in a 4° C. ice chamber for 2 hours;

3. getting the dough, then kneading it evenly, then wrapping it with plastic wrap, and then stewing for 15 minutes;

4. dividing the dough into blocks, wherein each of the blocks is approximately 50 grams, then pressing and rolling it into a circular casing, and then packaging 70 grams of the green rice with the circular casing; and

5. molding the dough wrapping with the green rice in a cake tin to obtain a green rice icing moon cake, and then packaging.

### Example 77

The green rice egg yolk moon cake is comprised the following ingredients or having a mass ratio thereof: 140 grams of cooked low-gluten flour, 40 grams of cream, 53 grams of sugar, 13 grams of milk powder, 20 grams of maltose, 50 grams of egg, 2 grams of salt, 600 grams of green rice, and 200 grams of salted egg yolks which are about 20 eggs total. The manufacturing method comprises the following steps of:

1. adding the cream, the milk powder, the maltose, and the sugar into a container, and then stirring;

2. adding the egg yolks two at a time and stirring evenly, and then adding the salt and stirring evenly to obtain an egg paste;

3. sieving the low-gluten flour and adding the egg paste, and then kneading it into a dough;

4. wrapping with a plastic wrap and stewing for 30 minutes, and then allowing the dough to relax;

5. cooking the salted egg yolks;

6. flattening the dough, then packaging 30 grams of the green rice on the flattened dough, and then adding a cooked egg yolk in the flattened dough to obtain the moon cake;

7. sprinkling water on the moon cake and transferring it into an oven;

8. First, baking for 10 minutes at 250° C., and second, baking at 200° C. for 10 minutes; all the while taking the moon cake out twice during baking to paint egg whites on the surface; and

9. baking at 250° C. for 5 minutes, then baking at 200° C. for 20 minutes, then removing from the oven and allowing it to cool naturally, and then packaging.

### Example 78

The green rice dumpling is comprised the following ingredients or having a mass ratio thereof: 300 grams of glutinous rice, 300 grams of pearl rice, 600 grams of streaky pork, 100 grams of bitter gourd, 200 grams of water, 100 grams of beef, 20 dumpling leaves, 1 gram of salt, 1 gram of sugar, and 1 gram of soy sauce. The manufacturing method comprises the following steps of:

1. cutting 80 grams of bitter gourd into blocks, then adding them into a blender, and then processing to obtain the bitter gourd juice;

2. cleaning the glutinous rice and the pearl rice with water, and then adding them to the bitter gourd juice to soak for 2 hours;

3. removing the glutinous rice and the pearl rice and draining;

4. cleaning the streaky pork, and then cutting it into strips;

5. cutting 20 grams of the bitter gourd into blocks;

6. cutting the beef into blocks;

7. adding the streaky pork, the bitter gourd, the beef, the white sugar, and the salt, and then stirring evenly and salting for 2 hours;

8. heating the dumpling leaves in boiling water for 1 minute;

9. taking two dumpling leaves and folding then into a funnel-shape, then adding 60 grams of soaked glutinous rice and pearl rice, 60 grams of streaky pork, 2 grams of bitter gourd, and 10 grams of beef, then forming to obtain a rice dumpling, and then fastening tightly by a string; and

11. boiling for 4 hours, then allowing it to naturally cool, and then packaging the dumpling leaves.

### Example 79

The green rice tortoise jelly paste tart is comprised the following ingredients or having a mass ratio thereof: 200 grams of flour, 4 eggs, 170 grams of milk, 80 grams of vegetable oil, 70 grams of white sugar, 1 grams of salt, 150 grams of water, 1 gram of vanilla oil, 1 gram of black sesame powder, 1 gram of tortoise shell powder, 1 gram of glabrous greenbrier rhizome powder, 1 gram of grass jelly powder, and 1 gram of the green rice. The manufacturing method comprises the following steps of:

1. adding 20 grams of sugar into 25 grams of water to obtain an amount of syrup;

2. adding the salt, the vegetable oil, and 20 grams of milk into the syrup;

3. adding the 2 eggs and stirring evenly to obtain the corresponding egg liquid.

4. adding the flour and kneading to obtain a dough;

5. flattening the dough into a round tart casing, and then adding it into a tart mold and compacting;

6. Stirring evenly 2 eggs to obtain egg liquid, then mixing with 150 grams of milk, then pouring 50 grams of white sugar, 125 grams of water, the black sesame powder, the tortoise shell powder, the glabrous greenbrier rhizome powder, the grass jelly powder, the green rice, and the vanilla oil and stirring to obtain the black egg juice;

7. pouring the black egg juice into the tart mold having an egg tart casing until 90% of the space of the tart mold is filled; and

8. placing the black egg tart in an oven and baking for 20 minutes at 180° C., and then removing it from the oven and allowing it naturally cool.

### Example 80

The green rice fried hot dog roll is comprised the following ingredients or having a mass ratio thereof: 30 grams of the green rice, 15 grams of cooked hot dog, 10 grams of flour, 50 grams of egg (1 egg), and 20 grams of flour. The manufacturing method comprises the following steps of:

1. paving the green rice;

2. placing the hot dogs on the green rice;

3. kneading the green rice and hot dogs into a round roll;

4. coating with the flour;

5. coating evenly with the egg liquid;

6. lastly, coating evenly with flour, and;

7. frying the roll coated with flour and egg liquid at 180° C. in pot of oil until the surface of the roll is golden brown, then removing and draining the excess oil, and then packaging.

### Example 81

The purple rice is comprised the following ingredients or having a mass ratio thereof: 15 grams of the purple rice, 20 grams of sliced cooked salmon, 10 grams of tomato, 10 grams of lettuce, 10 grams of sliced carrot, and two grams of purple laver. The manufacturing method comprises the following steps of:

1. pressing the purple rice into a flat oval shape; and

2. placing the sliced cooked salmon, the sliced tomato, the sliced lettuce and the sliced carrot on the purple rice, then wrapping tightly, and then packaging.

### Example 82

The purple rice is comprised the following ingredients or having a mass ratio thereof: 15 grams of the purple rice, 20 grams of sliced cooked hot dog, 10 grams of sliced tomato, 10 grams of lettuce, 10 grams of sliced carrot, and 2 grams of purple laver. The manufacturing method comprises the following steps of:

1. pressing the purple rice into a flat oval shape; and

2. placing the sliced cooked hot dog, the sliced tomato, the sliced lettuce and the sliced carrot on the purple rice, then enveloping tightly, and then packaging.

### Example 83

The purple rice purple roll is comprised the following ingredients or having a mass ratio thereof: 80 grams of the purple rice, 40 grams of sliced cooked salmon, 10 grams of tomato, 10 grams of lettuce, 10 grams of sliced carrot a piece of purple laver, and two cooked hot dogs, wherein the two hot dogs have an approximate weight of 40 grams. The manufacturing method comprises the following steps of:

1. slicing the cooked salmon into strips, wherein each of the strips is 20 grams;

2. placing the piece of layer on a bamboo mat, then placing the purple rice on the piece of laver, then placing two piece of the sliced cooked salmon, two cooked hot dogs, the sliced tomato, the sliced carrot, and the lettuce on the purple rice and rolling to obtain an elongated strip, and then pressing; and

3. cutting the rolled white rice purple roll into six blocks, and then packaging.

### Example 84

The purple rice tofu skin sushi is comprised the following ingredients or having a mass ratio thereof: 20 grams of fried tofu bubble, 15 grams of the purple rice, 20 grams of sliced meatball containing lobster, 10 grams of sliced tomato, and 10 grams of sliced carrot. The manufacturing method comprises the following steps of:

1. mashing the inner of the fried tofu bubble; and

2. placing the purple rice into the fried tofu bubble, then putting the sliced meatball containing lobster, the sliced tomato, and the sliced carrot on the purple rice, and then packaging.

### Example 85

The purple rice sausage sushi is comprised the following ingredients or having a mass ratio thereof: 100 mm casing for sausage, 10 grams of vegetable oil, 500 grams of rice, 100 grams of Colocasia Tonoimo, 20 grams of Colocasia Tonoimo powder, 1120 grams of water, 100 grams of peanut, 20 grams of small shrimp, 2 grams of salt, and 2 grams of sugar. The manufacturing method comprises the following steps of:

1. adding the Colocasia Tonoimo in a steamer to steam;

2. adding 100 grams of water and making the Colocasia Tonoimo juice with a blender;

3. cleaning the rice and adding the Colocasia Tonoimo juice to soak for 6 hours;

4. cleaning the peanuts and adding them into water to soak for 6 hours;

5. soaking the small shrimp for 10 minutes in water, and then chopping;

6. cleaning the casings, and then adding them into water to soak for 2 hours;

7. adding the chopped small shrimp into a pot to fry, then adding the Colocasia Tonoimo powder, the salt, the sugar, and the soaked rice and stirring evenly to obtain the purple rice stuffing;

8. pouring the vegetable oil into the casings for the sausage, and filling the casings with the purple rice stuffing;

9. putting the purple rice sausage in the steamer and steaming for 30 minutes; and

10. cutting the purple rice sausage into purple rice sausage sushi after removing the purple rice sausage from the steamer, wherein each of the pieces of the purple rice sausage sushi is approximately 20 g, and then packaging.

### Example 86

The purple rice bread roll is comprised the following ingredients or having a mass ratio thereof: 100 grams of purple rice, 2 pieces of rice bread, 20 grams of sliced cooked hot dog, 10 grams of sliced tomato, 10 grams of lettuce, and 10 grams of sliced carrot, wherein the two pieces of the rice bread have an approximate weight of 100 grams. The manufacturing method comprises the following steps of:

1. flattening 50 grams of the purple rice;

2. putting the sliced cooked hot dogs in the middle of the flattened purple rice;

3. flattening another 50 grams of the purple rice on the flattened purple rice;

4. pressing by a mold to obtain a roll;

5. placing the sliced tomato, the lettuce, the sliced carrot on one of the two rice breads each of which having a weight of 50 grams;

6. placing the roll on one of the two rice breads; and

7. Placing the other rice bread on the roll, then clamping tightly, and then packaging.

### Example 87

The purple rice bread egg sushi is comprised the following ingredients or having a mass ratio thereof: 20 grams of purple rice, 15 grams of sausage, 2 grams of sesame, and 2 grams of crab roe. The manufacturing method comprises the following steps of:

1. cutting the sausage into pieces;

2. adding the purple rice into the mold for egg casings, and then molding and removing the purple rice; and

3. spreading the pieces of sausage, the sesame seeds, and the crab roe on the purple rice, and then packaging.

### Example 88

The purple rice cylindrical pastry cup sushi is comprised the

following ingredients or having a mass ratio thereof: 1 cylindrical pastry cup, 30 grams of the purple rice, 20 grams of sausage, 2 grams of sesame, and 2 grams of crab roe. The manufacturing method comprises the following steps of:

1. cutting the sausage;

2. adding the purple rice into the cylindrical pastry cup; and

3. spreading the cut sausage, the sesame seeds, and the crab roe on the purple rice, and then packaging.

### Example 89

The purple rice icing moon cake is comprised the following ingredients or having a mass ratio thereof: 50 grams of cooked low-gluten flour, 50 grams of cooked glutinous rice flour, 10 grams of the Colocasia Tonoimo powder, 40 grams of white sugar, 180 grams of milk, 50 grams of condensed milk, and 1400 grams of the purple rice. The manufacturing method comprises the following steps of:

1. adding the cooked low-gluten flour, the cooked glutinous rice flour, the Colocasia Tonoimo powder, the white sugar, the milk, and the condensed milk into a container and stirring it to a paste, and then steaming 30 minutes to obtain a rice dough;

2. removing the rice dough, then allowing it to cool to room temperature, and then placing in a 4° C. ice chamber for 2 hours;

3. getting the dough, kneading it evenly and wrapping with a plastic wrap, and then stewing for 15 minutes;

4. dividing the dough into blocks, wherein each of blocks is approximately 50 grams, then pressing and rolling it into a circular casing, and then packaging 70 grams of the purple rice in the circular casing; and

5. molding the dough wrapping with the purple rice in a cake tin to obtain a purple rice icing moon cake, and then packaging.

### Example 90

The purple rice egg yolk moon cake is comprised the following ingredients or having a mass ratio thereof: 140 grams of cooked low-gluten flour, 40 grams of cream, 53 grams of white sugar, 13 grams of milk powder, 20 grams of maltose, 50 grams of egg, 2 grams of salt, 600 grams of purple rice, and 200 grams of salted egg yolks which are about 20 eggs total. The manufacturing method comprises the following steps of:

1. adding the cream, the white sugar, the milk powder, and the maltose into a container, and stirring evenly;

2. adding the egg yolk two at a time and stirring evenly, and then adding the salt and stirring evenly to obtain an egg paste;

3. sieving the low-gluten flour and adding the egg paste, and then kneading it into a dough;

4. wrapping with plastic wrap, then stewing for 30 minutes, and then allowing the dough to relax;

5. cooking the salted egg yolks;

6. flattening the dough, then packaging 30 grams of the purple rice on the flattened dough, and then adding a cooked egg yolk on the flattened dough to obtain the moon cake;

7. sprinkling water on the moon cake and transferring it into an oven;

8. first, baking for 10 minutes at 250° C., and second, baking at 200° C. for 10 minutes, all the while taking the moon cake out twice during baking to paint egg white on the surface; and

9. baking at 250° C. for 5 minutes, then baking at 200° C. for 20 minutes, then removing from the oven and allowing the moon cake to cool naturally, and then packaging.

### Example 91

The purple rice dumpling is comprised the following ingredients or having a mass ratio thereof: 300 grams of glutinous rice, 300 grams of pearl rice, 600 grams of streaky pork, 100 grams of Colocasia Tonoimo, 20 grams of Colocasia Tonoimo powder, 200 grams of water, 100 grams of duck, 100 grams of fried meat, 20 dumpling leaves, 1 gram of salt, 1 gram of sugar, and 1 gram of soy sauce. The manufacturing method comprises the following steps of:

1. cutting the Colocasia Tonoimo into blocks, and then adding into a steamer for 30 minutes;

2. processing half of the steamed Colocasia Tonoimo in a blender with water, and then stirring to obtain Colocasia Tonoimo juice;

3. cleaning the glutinous rice and the pearl rice with water, then adding the Colocasia Tonoimo juice to soak for 2 hours;

4. getting out of the glutinous rice and the pearl rice from the water and draining;

5. cleaning the streaky pork, and then cutting it into strips;

6. cutting the fried meat into strips;

7. cutting the duck into blocks;

8. cutting the another half of the Colocasia Tonoimo into blocks;

8. mixing the streaky pork, the fried meat, the duck and the white sugar, the salt, and the soy sauce, and then stirring evenly and salting for 2 hours;

9. heating the dumpling leaves in boiling water for 1 minute;

10. taking two dumpling leaves and folding them into a funnel-shape, then adding 60 grams of soaked glutinous rice and pearl rice, 60 grams of streaky pork, 2 grams of bitter gourd, 10 grams of duck, 10 grams of fried meat, 5 grams of Colocasia Tonoimo, then forming to obtain a rice dumpling, and then fastening tightly by a string; and

11. boiling for 4 hours, then allowing the dumping to naturally cool, and then packaging the dumpling leaves.

### Example 92

The purple rice tortoise jelly paste tart is comprised the following ingredients or having a mass ratio thereof: 200 grams of flour, 200 grams of egg (4 eggs), 170 grams of milk, 80 grams of vegetable oil, 70 grams of white sugar, 1 gram of salt, 150 grams of water, 1 gram of vanilla oil, 1 gram of black sesame powder, 1 gram of tortoise shell powder, 1 gram of glabrous greenbrier rhizome powder, 1 gram of grass jelly powder, and 1 gram of the purple rice. The manufacturing method comprises the following steps of:

1. adding 20 grams of sugar into 25 grams of water to obtain an amount of syrup;

2. adding the salt, the vegetable oil, and 20 grams of milk into the syrup;

3. adding the 2 eggs and stirring evenly to obtain the corresponding egg liquid;

4. adding the flour, and then kneading it to obtain a dough;

5. flattening the dough into a round tart casing, and then adding into a tart mold and compacting;

6. stirring 2 eggs evenly to obtain the egg liquid, then mixing with 150 grams of milk, and then pouring 50 grams of white sugar, 125 grams of water, the black sesame powder, the tortoise shell powder, the glabrous greenbrier rhizome powder, the grass jelly powder, the purple rice, and the vanilla oil and stirring to obtain the black egg juice;

7. pouring the black egg juice into the tart mold having an egg tart casing until 90% of the space of the tart mold is filled; and

8. placing the black egg juice tart in an oven and baking for 20 minutes at 180° C., and then removing and allowing the black egg juice tart to naturally cool.

### Example 93

The purple rice fried hot dog roll is comprised the following ingredients or having a mass ratio thereof: 30 grams of the purple rice, 15 grams of cooked hot dog, 10 grams of flour, 50 grams of egg (a single egg), and 20 grams of flour. The manufacturing method comprises the following steps of:

1. paving the purple rice;

2. placing the hot dogs on the purple rice;

3. kneading the purpose rice and hot dog into a round roll;

4. coating the round roll with flour;

5. coating the round roll evenly with egg liquid;

6. coating the round roll evenly with flour again, and

7. frying the round roll coated with the flour and egg liquid at 180° C. in pot of oil until the surface of the roll is golden brown, then removing it from the pot and draining the excess oil, and then packaging.

The food containing rice and flour ingredients of the present invention can effectively retain nutritional ingredients from fruits, vegetables, meats, eggs, seafood, and herbal medicines, not only is able to meet the nutritional needs of the human body for carbohydrates, protein, fat, dietary fiber, minerals, and vitamins, but also is available in a wide variety of flavors, has an aesthetic appeal, and tastes good. Simultaneously, each of the colors of food has its own unique health benefits. The red food containing rice and flour ingredients is made from red beans, which has properties of anti-swelling, detoxifying, dehumidification, and generating blood in the human body. The yellow food containing rice and flour is made from turmeric curry, which is able to promote a healthy appetite, enhance blood circulation, improve the immune system, replenish the body, and prevent diseases. The black food containing rice and flour is made from black sesame seeds, tortoise shell and the glabrous greenbrier rhizome powder, which is able to benefit the liver and kidney, nourishes blood, detoxifies the body. The white food is made from the copra and has plenty of protein and vitamins. The orange food is made from carrot, which is able to invigorate and detoxify the human body, acts as an aphrodisiac, and lower gas cough. The green food contains spinach, which is able to have the blood haemostatic Lee five internal organs, through the stomach, tune in the air, live blood, thirst quencher and intestines, grabbing yin and moistening, aid digestion effect. The purple food contain Colocasia Tonoimo, which is able to benefiting and the Catharsis, detoxification, fill in the liver and kidney benefits, swelling and pain, stomach and spleen, regulation the gas, phlegm, Tim myeloid Lean effect.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A healthy food, including a mass ratio of 226.795 g of flour, 25 g of egg yolks, 141.75 g of butter, 28.35 g of evaporated milk, 20 g of sugar, 1 g of yellow rice, 5 g of tortoise shell powder, 5 g of glabrous greenbrier rhizome, 5 g of Chinese meson, and 5 g of Ganoderma lucidum powder, 5 g of honey water.

2. A healthy food, including a mass ratio of 200 g of flour, 5 g of milk, 50 g of egg, 80 g of margarine, 60 g of lard oil, 20 g of icing sugar, a little of salt, 150 g of egg, 150 g of milk, 50 g of white sugar, 135 g of water, an amount of vanilla oil, 5 g of black sesame powder, and 5 g of tortoise jelly powder.

3. A healthy food, including a mass ratio of 60 g of red rice, 60 g of yellow rice, 60 g of black rice, 60 g of white rice, 60 g of orange rice, 60 g of green rice, 60 g of purple rice, and two pieces of laver, wherein the layer has a thickness of 1 mm; wherein from top to bottom, the laver, the red rice, the yellow rice, the black rice, the white rice, the orange rice, the green rice, the purple rice, and the layer are orderly arranged by layer, wherein each of layers has a thickness of 5-8 mm and each unit of the healthy food has a weight of 40 g, 50 g, 80 g or 100 g.

4. The healthy food, as recited in claim 3, wherein the red rice includes a mass ratio of 500 g of rice, 1520 g of water, 100 g of red bean, 20 g of red bean powder, 1 g of salt, and 1 g of sugar, wherein the red rice is made by a manufacturing method comprising the step of:
(a) adding the red beans into 520 g of water in a container and cooking for 1 hour;
(b) adding red bean powder, salt and sugar into the container, stirring to obtain red bean paste water;
(c) adding rice and 1000 g of water into a rice cooker and cooking to prepare rice; and
(d) mixing the red bean paste water and the rice and stirring until the red bean paste water is completely and evenly absorbed by the rice to prepare the red rice.

5. The health food, as recited in claim 1, wherein the yellow rice includes a mass ratio of 500 g of rice, 1050 g of water, 50 g of turmeric curry powder, 1 gram of salt, and 1 g of sugar, wherein the yellow rice is made by a manufacturing method comprising the step of:
(a) adding the turmeric curry powder, the salt and the sugar into 50 g of water in a container;
(b) stirring evenly to obtain turmeric curry water;
(c) adding the rice and 1000 g of water into a rice cooker and cooking to prepare the rice; and
(d) mixing the turmeric curry water and the rice and stirring until the turmeric curry water is completely and evenly absorbed by the rice to prepare the yellow rice.

6. The health food, as recited in claim 3, wherein the yellow rice includes a mass ratio of 500 g of rice, 1050 g of water, 50 g of turmeric curry powder, 1 gram of salt, and 1 g of sugar, wherein the yellow rice is made by a manufacturing method comprising the step of:
(a) adding the turmeric curry powder, the salt and the sugar into 50 g of water in a container;
(b) stirring evenly to obtain turmeric curry water;
(c) adding the rice and 1000 g of water into a rice cooker and cooking to prepare the rice; and
(d) mixing the turmeric curry water and the rice and stirring until the turmeric curry water is completely and evenly absorbed by the rice to prepare the yellow rice.

7. The health food, as recited in claim 6, wherein the black rice includes a mass ratio of 500 g of rice, 1120 g of water, 100 g of black sesame powder, 10 g of black sesame, 10 g of tortoise shell powder, 10 g of glabrous greenbrier rhizome, 1 gram of salt, and 1 g of sugar, wherein the black rice is made by a manufacturing method comprising the step of:
(a) adding the black sesame powder, the tortoise shell powder, the glabrous greenbrier rhizome and 120 g of water into a container and cooking for 1 hour;
(b) adding the salt, the sugar, stirring evenly to obtain black sesame water;
(c) adding rice and 1000 g of water into a rice cooker and cooking to prepare rice; and
(d) mixing the black sesame water and the rice and stirring until the black sesame water is completely and evenly absorbed by the rice to prepare the black rice.

8. The health food, as recited in claim 7, wherein the white rice includes a mass ratio of 500 g of rice, 1120 g of water, 100 g of copra, 20 g of coconut powder, 3 gram of salt, and 3 g of sugar, wherein the white rice is made by a manufacturing method comprising the step of:
(a) smashing the copra with 120 g of water, filtering to obtain coconut milk;
(b) adding the coconut powder, the salt, the sugar, stirring evenly to obtain coconut water;
(c) adding rice and 1000 g of water into a rice cooker and cooking to prepare rice;
(d) mixing the coconut water and the rice and stirring until the coconut water is completely and evenly absorbed by the rice to prepare the white rice.

9. The health food, as recited in claim 8, wherein the orange rice includes a mass ratio 500 g of rice, 1120 g of water, 100 g of carrot, 20 g of carrot powder, 1 gram of salt, and 1 g of sugar, wherein the orange rice is made by a manufacturing method comprising the step of:
(a) smashing the carrot with 120 g of water, filtering to obtain carrot juice;
(b) adding the carrot powder, the salt, the sugar, stirring evenly to obtain carrot water;
(c) adding rice and 1000 g of water into a rice cooker and cooking to prepare rice; and
(d) mixing the carrot water and the rice and stirring until the carrot water is completely and evenly absorbed by the rice to prepare the orange rice.

10. The health food, as recited in claim 9, wherein the green rice includes a mass ratio of 500 g of rice, 1120 g of water, 100 g of spinach, 20 g of spinach powder, 1 gram of salt, and 1 g of sugar, wherein a manufacturing method for the green rice comprises the steps of:
(a) cleaning the spinach and smashing it with 120 g of water, filtering to obtain spinach juice;
(b) adding the spinach powder, the salt, the sugar, stirring evenly to obtain spinach water;
(c) adding rice and 1000 g of water into a rice cooker and cooking to prepare rice; and
(d) mixing the spinach water and the rice and stirring until the spinach water is completely and evenly absorbed by the rice to prepare the spinach rice.

11. The health food, as recited in claim 10, wherein the purple rice includes a mass ratio of 500 g of rice, 1120 g of water, 100 g of colocasia tonoimo, 20 g of colocasia tonoimo powder, 1 gram of salt, and 1 gram of sugar, wherein a manufacturing method for the purple rice comprises the steps of:
(a) peeling and cleaning the colocasia tonoimo, after dicing, steaming for 1 hour in a food steamer,
(b) smashing the steamed colocasia tonoimo and with 120 g of water to obtain a mixture of colocasia tonoimo paste and water;
(c) adding the colocasia tonoimo powder, the salt, the sugar, stirring evenly to obtain colocasia tonoimo water;
(d) adding rice and 1000 g of water into a rice cooker and cooking to prepare cooked rice; and
(e) mixing the colocasia tonoimo water and the rice and stirring until the spinach water is completely and evenly absorbed by the rice to prepare the purple rice.

12. The healthy food, as recited in claim 11, wherein the red rice, the yellow rice, the black rice, the white rice, the orange rice, the green rice and/or the purple rice is provided in an rice bread, a fried tofu bubble or a cylindrical pastry cup, wherein the fruits and/or vegetables, meats, eggs and/or aquatic products are orderly placed on the rice or the fruit and/or vegetable, meat, egg and/or aquatic product are orderly placed on the rice, the meat being a cooked hot dog, the egg being a single-sided fried egg or double-sided fried egg, the aquatic product being a cooked meatball containing lobster, a piece of sliced salmon, the red vegetable being a piece of tomatoes and/or carrot, the vegetable is a piece of lettuce.

13. The healthy food, as recited in claim 12, wherein the fried tofu bubble contains the following ingredients, which having a mass ratio of 25 g of tofu and 3 g of edible oil, which is made by a manufacturing method comprising the steps of:
(i) drying the tofu;
(ii) preparing the edible oil in a container and heating to 60-70° C., and then adding the dried tofu into the container;
(iii) frying the dried tofu for 3 minutes, preferably using up 3 g of edible oil; and
(iv) slicing an opening which has a depth of 0.5 mm in a side of each of fried tofu bubbles.

14. The healthy food, as recited in claim 12, wherein the rice bread includes a mass ratio of 415 g of high-gluten flour, 25 g of egg, 50 g of butter, 10 g of dried milk, 2 g of salt, 60 g of sugar, 15 g of baking powder, 225 g of 35° C. water, 100 g of rice, 20 g of colocasia tonoimo powder, 200 g of water, and 20 g of colocasia tonoimo, which is made by a manufacturing method comprising the steps of:
(i) dicing a colocasia tonoimo, and then adding the rice and cooking to obtain the cooked purple rice, and stirring evenly;
(ii) preparing the beaten eggs;
(iii) adding the baking powder into the warm water, and then adding the high-gluten flour, the beaten egg, the salt, the sugar, and then stirring;
(iv) kneading the high-gluten flour mixture into a dough, and then adding butter and kneading evenly;
(v) fermenting the kneaded dough for 1 hour;
(vi) dividing the fermented dough into 20 g small dough, leaving them quietly 10 minutes;
(vii) rolling the small dough with a rolling pin, and then adding the purple rice and kneading evenly, and then fermenting for 30 minutes,
(viii) smearing the beaten eggs on surfaces of the fermented small dough;
(ix) baking them in an oven for 10 minutes at 200° C.; and
(x) cutting each of the baked breads into two pieces.

15. The healthy food, as recited in claim 12, wherein the cooked meatball includes a mass ratio of the 200 g of the lobster, 200 g of fish, 100 g of pork, 50 g of egg, 80 g of millet flour, 5 g of pepper powder, 500 g of water, 2 g of salt, and 2 g of sugar, which is made by a manufacturing method comprising the steps of:
(i) cutting up the fish;
(ii) shelling lobsters and cutting up;
(iii) cutting the pork;
(iv) mixing the cut fish, lobster meat and pork, and then adding the salt, the sugar and the pepper powder, and mixing beaten eggs into the meat and stirring to obtain its meat paste;
(v) adding the millet flour into the meat paste, stirring evenly; and
(vi) squeezing the meat paste to obtain meatballs, wherein each of the meatballs has a 3 cm diameter, and then frying for 3 minutes at 60° C.-70° C. in a frying-pan to obtain cooked meatballs made of lobster, fish and pork meat.

16. The healthy food, as recited in claim 3, further comprising a cylindrical crust cup which includes a mass ratio of 200 g of flour, 60 g of egg, 50 g of butter, 20 g of evaporated milk, −1° C. ice water, 1 gram of salt, and 1 gram of sugar, which is made by a manufacturing method comprising the steps of:
(i) mixing the butter, the salt and the sugar and stirring evenly;
(ii) adding the eggs and stirring evenly;
(iii) adding the flour, the evaporated milk and the ice water and kneading to obtain a dough;
(iv) rolling the dough to obtain a 1 mm flour wrapper and dividing it into 20 g of pieces of flour wrapper; and
(v) rolling pieces of flour wrapper by a crust tin to obtain crusts, and then baking them in an oven at 180° C. for 20 minutes to obtain cylindrical crust cups.

17. The healthy food, as recited in claim 13, further comprising a cylindrical crust cup which includes a mass ratio of 200 g of flour, 60 g of egg, 50 g of butter, 20 g of evaporated milk, −1° C. ice water, 1 gram of salt, and 1 gram of sugar, which is made by a manufacturing method comprising the steps of:
(i) mixing the butter, the salt and the sugar and stirring evenly;
(ii) adding the eggs and stirring evenly;
(iii) adding the flour, the evaporated milk and the ice water and kneading to obtain a dough;
(iv) rolling the dough to obtain a 1 mm flour wrapper and dividing it into 20 g of pieces of flour wrapper; and
(v) rolling pieces of flour wrapper by a crust tin to obtain crusts, and then baking them in an oven at 180° C. for 20 minutes to obtain cylindrical crust cups.

18. The healthy food, as recited in claim 14, further comprising a cylindrical crust cup which includes a mass ratio of 200 g of flour, 60 g of egg, 50 g of butter, 20 g of evaporated milk, −1° C. ice water, 1 gram of salt, and 1 gram of sugar, which is made by a manufacturing method comprising the steps of:
(i) mixing the butter, the salt and the sugar and stirring evenly;
(ii) adding the eggs and stirring evenly;
(iii) adding the flour, the evaporated milk and the ice water and kneading to obtain a dough;
(iv) rolling the dough to obtain a 1 mm flour wrapper and dividing it into 20 g of pieces of flour wrapper; and
(v) rolling pieces of flour wrapper by a crust tin to obtain crusts, and then baking them in an oven at 180° C. for 20 minutes to obtain cylindrical crust cups.

19. A method for manufacturing a health food containing rice and wheat flour comprising the steps of:
(a) preparing egg tarts which comprises the steps of
(a1) adding 40° C. water to 20 g of icing sugar and mixing to obtain an amount of syrup;
(a2) adding little salt, 60 g of lard oil, 80 g of margarine, 5 g of milk, and stirring to obtain thin paste;
(a3) adding 50 g of eggs, and stirring evenly;
(a4) adding 200 g of flour and kneading to obtain a dough; and
(a5) adding the dough into a mold and pressing to obtain egg tarts; and
(b) preparing stuffing which comprises the steps of:
(b1) dissolving 50 g of white sugar in 135 g of water to obtain an amount of syrup, stirring 150 g of egg to obtain egg liquid, and then adding 150 g of milk, the syrup, 5 g of black sesame powder, 5 g of tortoise jelly powder and little vanilla oil, stirring evenly to obtain black juice; and
(b2) pouring the black juice into the baked egg tarts until the black juice fills 90% space of each of the baked egg tarts; preparing pastry tortoise jelly paste egg tarts; and
(c) transferring the egg tarts in the mold and the black juice in the egg tarts into an oven and baking at 180° C. for 20 minutes, getting out of the oven and naturally cooling them to room temperature to obtain the pastry tortoise jelly paste egg tarts.

20. A method for manufacturing health food containing rice and flour ingredients, comprising the steps of:
(a) adding one piece of 1 mm layer sheet on the bottom of a mold;
(b) covering evenly and orderly 60 g of the red rice, 60 g of the yellow rice, 60 g of the black rice, 60 g of the white rice, 60 g of an orange rice, 60 g of green rice, 60 g of purple rice;
(c) covering one piece of 1 mm layer sheet on the purple rice, pressing a mold on the seaweed layer sheet to obtain rice food having seven-color cross-section; and
(d) dividing the seven-color rice into blocks along a direction vertical to the layer sheets, wherein the blocks have a block size selected from 40 g, 50 g, 80 g, and 100 g, and each of rice layers has a thickness of 5-8 mm.
